(19) United States
(12) Patent Application Publication
(10) Pub. No.: US 2026/0333432 A1
(43) Pub. Date: Oct. 22, 2026

(54) DETERMINING A TRANSMISSION OCCASION FOR AMBIENT INTERNET OF THINGS COMMUNICATION

(71) Applicant: Lenovo (United States) Inc., Morrisville, NC (US)

(72) Inventors: Genadi Velev, Darmstadt (DE); Thomas Luetzenkirchen, Berlin (DE); Hyung-Nam Choi, Ottobrunn (DE)

(73) Assignee: Lenovo (United States) Inc., Morrisville, NC (US)

(21) Appl. No.: 19/281,139

(22) Filed: Jul. 25, 2025

(51) Int. Cl. H04W 74/0816; H04W 8/22; H04W 64/00

(52) U.S. Cl. CPC H04W 74/0816; H04W 8/22; H04W 64/00

(57) ABSTRACT

Various aspects of the present disclosure relate to determining a transmission occasion for ambient internet of things (AIoT) communication. A reader device may obtain an indication that an expected service processing time associated with an AIoT device satisfies (e.g., exceeds, is greater than) a threshold value. For example, a network entity including or implementing an AIoT function (AIOTF) may output the indication to the reader device. The reader device determines a duration of a transmission occasion associated with transmission of a second signaling from the AIoT device to the reader device. The duration is based on the expected service processing time associated with the AIoT device. The reader device transmits a first signaling to the AIoT device. The reader device receives the second signaling from the AIoT device during the transmission occasion and responsive to the first signaling.

### TECHNICAL FIELD

The present disclosure relates to wireless communications, and more specifically to configuring resources for wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE, reader device, network entity), processors, and methods of the present disclosure each have several innovative aspects, no single one of which is solely responsible for the desirable features disclosed herein.

A reader device (e.g., an NE or a UE) for wireless communication is described. The reader device may be configured to, capable of, or operable to perform one or more operations as described herein. For example, the reader device may be configured to, capable of, or operable to obtain (e.g., retrieve, receive) an indication that an expected service processing time associated with an ambient internet of things (AIoT) device satisfies (e.g., exceeds, is greater than) a threshold value, determine, based on the expected service processing time associated with the AIoT device, a duration of an occasion (e.g., a transmission occasion, time slot) associated with transmission of a second signaling from the AIoT device to the reader device, transmit a first signaling to the AIoT device, and receive, during the occasion and responsive to the first signaling, the second signaling from the AIoT device.

A processor (e.g., a standalone processor chipset, or a component of a reader device) for wireless communication is described. The processor may be configured to, capable of, or operable to perform one or more operations as described herein. For example, the processor may be configured to, capable of, or operable to obtain an indication that an expected service processing time associated with an AIoT device satisfies a threshold value, determine, based on the expected service processing time associated with the AIoT device, a duration of an occasion associated with transmission of a second signaling from the AIoT device to the reader device, transmit a first signaling to the AIoT device, and receive, during the occasion and responsive to the first signaling, the second signaling from the AIoT device.

A method performed or performable by a reader device for wireless communication is described. The method may include obtaining an indication that an expected service processing time associated with an AIoT device satisfies a threshold value, determining, based on the expected service processing time associated with the AIoT device, a duration of an occasion associated with transmission of a second signaling from the AIoT device to the reader device, transmitting a first signaling to the AIoT device, and receiving, during the occasion and responsive to the first signaling, the second signaling from the AIoT device.

In some implementations of the reader device, the processor, and the method described herein, the reader device, the processor, and the method may further be configured to, capable of, or operable to obtain the indication from an AIoT function (AIOTF) based on a command request message (e.g., from a network function), where the command request message includes one or more of a value of the expected service processing time, a battery storage capability of the AIoT device associated with the expected service processing time, an energy harvesting capability of the AIoT device associated with the expected service processing time, or a signal quality between the AIoT device and the device, an identifier (ID) associated with a network function associated with the command request message, location (e.g., target area) information that indicates a location of the AIoT device, or identification information associated with the AIoT device. In some implementations, the reader device, the processor, and the method may further be configured to, capable of, or operable to transmit, prior to the first signaling, third signaling to the AIoT device, determine a failure to receive fourth signaling responsive to the third signaling during an additional occasion between reception of the third signaling at the AIoT device and transmission of the fourth signaling at the AIoT device, and output, to an AIOTF, a notification indicating one or more of the failure to receive the fourth signaling from the AIoT device during the additional occasion or a duration of the additional occasion, where the second signaling includes a retransmission of the fourth signaling, and where the indication is obtained from the AIOTF responsive to the notification. In some implementations, a threshold (e.g., maximum) response time associated with the fourth signaling is extended based on the occasion being greater than or equal to the threshold response time. In some implementations, the expected service processing time associated with the AIoT device is based on one or more of a size of a command request message from the reader device, a size of a command response message from the AIoT device, or the duration of the additional occasion, where the first signaling includes the command request message, and where the second signaling includes the command response message.

In some implementations, the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. In some implementations, the indication indicates a failure corresponding to transmission or reception of a first command message, and where the first signaling includes a second command message that is a retransmission of the first command message based on the failure. In some implementations, stored AIoT context data associated with the AIoT device is updated based on one or more of a value of the expected service processing time, a battery storage capability of the AIoT device associated with the expected service processing time, an energy harvesting capability of the AIoT device associated with the expected service processing time, or a signal quality between the AIoT device and the reader device.

A network entity (e.g., a base station, a core network (CN), or other network equipment or device) for wireless communication is described. The network entity may be configured to, capable of, or operable to perform one or more operations as described herein. For example, the network entity may be configured to, capable of, or operable to output, to a reader device, an indication that an expected service processing time associated with an AIoT device satisfies a threshold value, where a duration of an occasion associated with transmission of signaling from the AIoT device to the reader device is based on the expected service processing time associated with the AIoT device.

A processor (e.g., a standalone processor chipset, or a component of a network entity) for wireless communication is described. The processor may be configured to, capable of, or operable to perform one or more operations as described herein. For example, the processor may be configured to, capable of, or operable to output, to a reader device, an indication that an expected service processing time associated with an AIoT device satisfies a threshold value, where a duration of an occasion associated with transmission of signaling from the AIoT device to the reader device is based on the expected service processing time associated with the AIoT device.

A method performed or performable by a network entity for wireless communication is described. The method may include outputting, to a reader device, an indication that an expected service processing time associated with an AIoT device satisfies a threshold value, where a duration of an occasion associated with transmission of signaling from the AIoT device to the reader device is based on the expected service processing time associated with the AIoT device.

In some implementations of the network entity, the processor, and the method described herein, the network entity, the processor, and the method may further be configured to, capable of, or operable to obtain, from a network function, a command request message including one or more of a value of the expected service processing time, a battery storage capability of the AIoT device associated with the expected service processing time, an energy harvesting capability of the AIoT device associated with the expected service processing time, or a signal quality between the AIoT device and the reader device, an ID associated with the network function, location information that indicates a location of the AIoT device, or identification information associated with the AIoT device. In some implementations, the network entity, the processor, and the method may further be configured to, capable of, or operable to obtain, from the reader device, a notification indicating one or more of a failure to receive the signaling from the AIoT device during an additional occasion prior to the occasion or a duration of the additional occasion. In some implementations, a threshold response time associated with the additional signaling is extended based on the occasion being greater than or equal to the threshold response time. In some implementations, the expected service processing time associated with the AIoT device is based on one or more of a size of a command request message from the reader device, a size of a command response message from the AIoT device, or the duration of the additional occasion, where the signaling includes the command response message.

In some implementations, the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. In some implementations, the indication indicates a failure corresponding to transmission or reception of a first command message, and where a second command message that is a retransmission of the first command message is transmitted based on the indication. In some implementations, the network entity, the processor, and the method may further be configured to, capable of, or operable to output, to an AIoT data management (ADM) function, a request to update AIoT data associated with the AIoT device based on one or more of a value of the expected service processing time, a battery storage capability of the AIoT device associated with the expected service processing time, an energy harvesting capability of the AIoT device associated with the expected service processing time, or a signal quality between the AIoT device and the reader device. In some implementations, the indication is output in a command request message, and the network entity, the processor, and the method may further be configured to, capable of, or operable to obtain, in response to the command request message, a command response message associated with the signaling. In some implementations, the network entity implements an AIOTF.

### BRIEF DESCRIPTION OF THE DRAWINGS

FIGS. 1 through 3 illustrate example of wireless communications systems in accordance with aspects of the present disclosure.

FIGS. 4 and 5 illustrates examples of network architectures, in accordance with aspects of the present disclosure.

FIGS. 6 through 9 illustrate examples of signaling diagrams, in accordance with aspects of the present disclosure.

FIG. 10 illustrates an example of a reader device in accordance with aspects of the present disclosure.

FIG. 11 illustrates an example of a processor in accordance with aspects of the present disclosure.

FIG. 12 illustrates an example of a network entity in accordance with aspects of the present disclosure.

FIG. 13 illustrates a flowchart of a method performed by a reader device in accordance with aspects of the present disclosure.

FIG. 14 illustrates a flowchart of a method performed by an network entity in accordance with aspects of the present disclosure.

### DETAILED DESCRIPTION

A wireless communications system can include one or more devices, such as AIoT devices and reader devices (e.g., UEs and/or NEs). In some examples, AIoT devices may have reduced energy storage capabilities when compared with other devices. For example, the AIoT devices may harvest energy from one or more sources, such as radio frequency energy, solar energy, wind energy, and more. Signaling from the reader device to the AIoT device may be referred to as reader-to-device (R2D) signaling or messages, while signaling from the AIoT device to the reader device may be referred to as device-to-reader (D2R) signaling or messages. The AIoT device may receive R2D signaling that provides energy to power the AIoT device, as well as configures the AIoT device to transmit D2R signaling in response to the R2D signaling. However, the AIoT device may be unable to power up, process the R2D signaling, and/or generate and transmit the D2R signaling within an allocated duration (e.g., time slot, transmission occasion). For example, a service processing time at the AIoT device may exceed (e.g., satisfy) the allocated duration due to a size of the R2D signaling, a size of the D2R signaling, a power level or capability of the AIoT device, or any other conditions. Thus, the AIoT device may fail to transmit the D2R signaling within the allocated duration, leading to increased signaling overhead and inefficient use of signaling resources related to retransmitting the R2D transmission even if the AIoT device receives the R2D signaling.

As described herein, to reduce transmission failures from an AIoT device related to an extended service processing time at the AIoT device, a reader device can configure an occasion for transmission of signaling from the AIoT device to the reader device using an expected service processing time for the AIoT device. The reader device can obtain (e.g., receive) an indication from a network entity including or implementing an AIOTF that an expected service processing time for the AIoT device exceeds a threshold value. In some cases, the AIOTF receives a command request message from another network function (e.g., a network exposure function (NEF) and/or an application function (AF)) that includes the expected service processing time for the AIoT device. In some other cases, the AIOTF receives a notification from the reader device that indicates the reader device failed to receive response signaling from the AIoT device during an initial transmission occasion. The AIOTF transmits the indication of the expected service processing time exceeding the threshold value to the reader device responsive to the command request message and/or the notification. The reader device determines a duration of a transmission occasion for D2R signaling that accounts for the expected service processing time. The reader device transmits R2D signaling to the AIoT device. The reader device monitors for and receives the D2R signaling during the transmission occasion that accounts for the expected service processing time.

By performing the described techniques, an AIOTF and a reader device (e.g., an AIoT reader) may adaptively configure transmission occasions for D2R signaling at an AIoT device according to an expected service processing time at the AIoT device to proactively prevent failures in D2R message transmissions. Additionally, or alternatively, if a transmission failure has already occurred, the AIOTF and the reader device may implement effective retransmission mechanisms that accommodate the extended processing criterion of AIoT devices. Thus, AIoT devices with reduced energy storage capabilities may successfully complete command operations despite longer processing times, thereby improving communication reliability and reducing signaling overhead.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

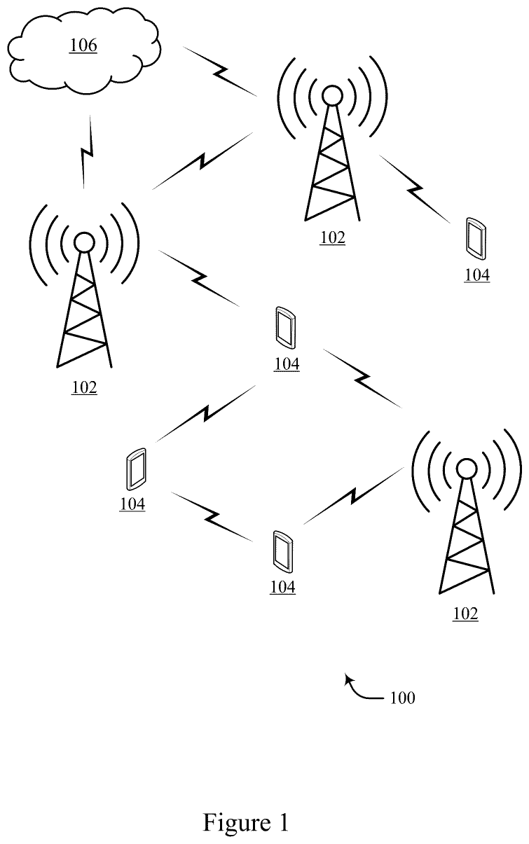

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU, such that the CU may support one or more layers of the protocol stack, and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A wireless communications system 100 (e.g., a 5G system (5GS)), which may also be referred to as a wireless network, may support cellular IoT services for devices with reduced capabilities. For example, the devices can include a new class of IoT devices, referred to as AIoT devices, which operate by harvesting energy from various environmental sources. The environmental sources can include, but are not limited to, radio frequency energy, solar energy, and wind energy, among other examples. AIoT devices do not rely on batteries and may have reduced energy storage capabilities when compared with other devices in the wireless communications system 100. The AIoT devices may utilize an internal capacitor for temporary energy or power storage. In some cases, the AIoT devices collect (e.g., obtain, harvest) radio frequency energy from transmissions made by devices in the wireless communications system 100, including NEs 102 and UEs 104. Radio frequency energy harvesting enables AIoT devices to capture and utilize energy from signaling or other radio frequency sources in an environment of the AIoT devices. For example, AIoT devices can harvest energy from radio frequency signals transmitted by NEs 102 or UEs 104 in a cellular network or from one or more devices in a Wi-Fi networks. The energy harvesting capability may provide for AIoT devices to operate without batteries or other power sources, while maintaining communication capabilities with other devices (e.g., in the wireless communications system 100 or in a Wi-Fi network). The radio frequency energy harvesting may also provide for AIoT devices to be deployed in locations without power sources, expanding the applications for IoT technology.

For an AIoT device to transmit data (e.g., within the wireless communications system 100 or in a Wi-Fi network), the AIoT device may receive a radio frequency signal that provides sufficient energy to power the operation of the AIoT device. The radio frequency signal that provides power to the AIoT device may be referred to as a trigger signal or a trigger message. The trigger signal can be transmitted by a reader device, which may be an example of an NE 102 (e.g., a base station, gNB, or other network device) or a UE 104. The reader device may be within a threshold distance (e.g., in close proximity to) the AIoT device to enable efficient energy transfer and reliable communication between the reader device and the AIoT device. The reader device serves as an intermediary between the AIoT device and other devices in the wireless communications system 100 or in a Wi-Fi network, facilitating the exchange of information, while accommodating the energy harvesting and storage capabilities of the AIoT device. In addition to providing power or energy to the AIoT device, the trigger signal may include configuration information that indicates to the AIoT device how and when to transmit a response signal.

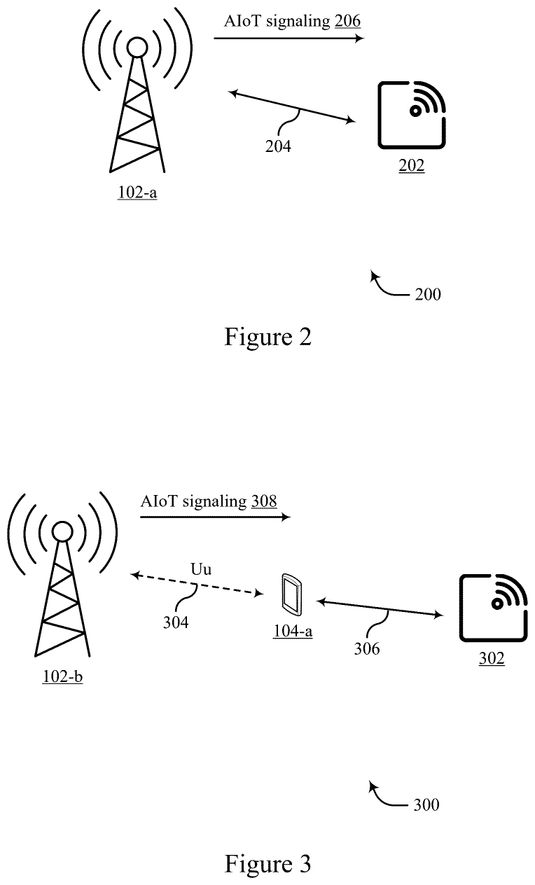

In some examples, the wireless communications system 100 may implement one or more topologies for communications between the AIoT devices and other devices in the wireless communications system 100 (e.g., NEs 102 and UEs 104). For example, an AIoT device may communicate directly with an NE 102, which is described in further detail with respect to FIG. 2. That is, a direct communication path may exist between an NE 102 acting as a reader device and the AIoT device. Communication between the NE 102 (e.g., reader device) and the AIoT device may include AIoT data and/or signaling. In some other examples, an AIoT device may communicate indirectly with an NE 102 via a UE 104, which is described in further detail with respect to FIG. 3. That is, communication between the AIoT device and an NE 102 occurs through an intermediary UE 104 that acts as a reader device between the NE 102 and the AIoT device. The UE 104 acting as the reader device may be capable of transmitting and receiving data and/or signaling to and from the AIoT device. In both topologies, the AIoT device may receive a carrier wave from other nodes either inside or outside of the defined topology. The communication links established between devices (e.g., AIoT devices, UEs 104, and NEs 102) in each topology may be either bidirectional or unidirectional, depending on the implementation and energy criterion or capability of the AIoT device. For example, if an AIoT device has reduced energy harvesting capabilities, then the communication link may be primarily unidirectional from the reader device to the AIoT device, with minimal response signaling from the AIoT device. In some other examples, if the AIoT device has access to additional or greater than a threshold amount of energy from energy harvesting sources, such as ambient light or thermal gradients, then the communication link may support full bidirectional communication with larger data payloads in both directions (e.g., to and from the AIoT device).

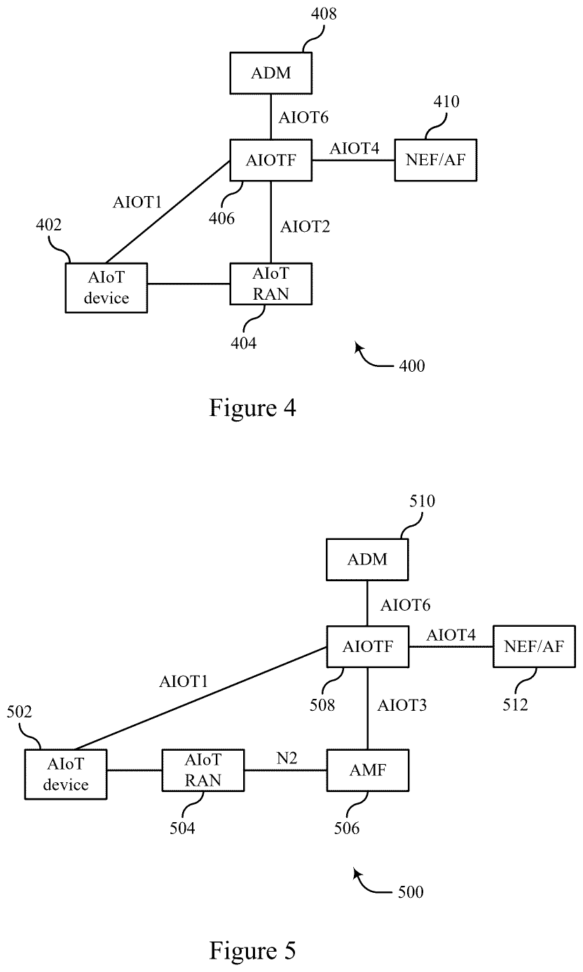

Within the AIoT communication framework, a communication direction from the reader device to the AIoT device can be notated as R2D, while a communication direction from the AIoT device to the reader device can be notated as D2R. The terms R2D and D2R may be used to describe AIoT message transmission or signaling transmission over a radio interface, which is also referred to as an access stratum (AS) layer. The AS layer may refer to a protocol layer that manages radio resources and handles direct communication between the AIoT device and the reader device, including radio resource control, mobility management, and data transfer over the wireless interface, among other examples. At an NAS layer, a message from an AIOTF to the AIoT device may be referred to as a downlink NAS message (e.g., NAS command request), while a message from the AIoT device to the AIOTF may be referred to as an uplink NAS message (e.g., NAS command response). The NAS layer may refer to a protocol layer that handles communication between the AIoT device and a CN 106, including one or more network functions implemented by the CN 106 that are responsible for authentication, security, and mobility management, among other examples. The AIOTF is a network function implemented by the CN 106 that supports AIoT services, including inventory and command operations, and selects the AIoT RAN nodes that serve defined service areas. Various network architectures that include network functions for AIoT communications are described in further detail with respect to FIGS. 4 and 5.

In some cases, UE radio interfaces provide for retransmission of AS messages between UEs 104 and RAN nodes (e.g., NEs 102) in the wireless communications system 100. However, an AIoT radio interface is designed for devices with reduced energy capabilities (e.g., AIoT devices) and may not inherently support retransmissions over the AIoT radio interface, which leads to failed transmissions or additional signaling overhead if AIoT devices utilize additional processing time or encounter communication difficulties. For example, AIoT devices may not support requesting a retransmission of signaling. If a reader device allocates (e.g., configures, assigns, indicates) a time slot to an AIoT device for a D2R message transmission and if the AIoT device is unable to generate the reply message within the allocated time slot due to an extended service processing time, then the AIoT device may not transmit the reply message within the time slot. That is, the D2R message may be available for transmission after the time slot has passed. The time slot may be referred to as a transmission occasion or a D2R occasion. The AIoT device may be unable to execute commands prior to expiry of a transmission occasion, including sending (e.g., transmitting, outputting) signaling in reply to a command request from a reader device, due to one or more conditions. The conditions can include a read or write message being too long, resulting in a longer time for execution. Additionally, or alternatively, the conditions can include an energy or power level at the AIoT device being below a threshold value, resulting in slow command operation execution. For example, a reader device can transmit an AS R2D command message including an NAS payload and information about the D2R occasion timing, but the AIoT device may be unable to complete command execution prior to the scheduled D2R occasion. The AIoT failing to complete the command execution prior to expiry of the D2R occasion may result in transmission failure, even if the AIoT device eventually completes the command successfully.

According to implementations, one or more devices (e.g., the NEs 102, the UEs 104, AIoT devices) in the wireless communications system 100 are operable to implement various aspects of the techniques described with reference to the present disclosure. For example, to accommodate the energy harvesting nature of AIoT devices, while ensuring reliable communication between the AIoT device and reader device, a reader device receives an indication that an expected service processing time for an AIoT device exceeds (e.g., satisfies) a threshold value. In some cases, a network entity (e.g., a CN 106) that includes or implements an AIOTF sends the indication of the expected service processing time exceeding the threshold to the reader device. The expected service processing time (e.g., denoted or referred to as an ESPT) is a time for which the AIoT device processes and executes a command, which may be extended due to reduced energy storage capability or radio coverage conditions that affect energy harvesting efficiency. The reader device determines a duration of a transmission occasion (e.g., time slot, D2R occasion) using the expected service processing time. The reader device transmits a signaling to the AIoT device, such as a R2D message that includes instructions for the AIoT device to transmit a D2R message within the transmission occasion. The reader device receives signaling from the AIoT device, such as the D2R message, during the transmission occasion.

In some cases, an AIOTF determines that the processing time of an AIoT service operation (e.g., command request) at an AIoT device is expected to exceed a threshold value. In other words, the AIOTF determines that the processing time of an AIoT service operation may be increased beyond one or more parameters. The AIOTF may instruct a reader device in the wireless communications system 100 to adapt a transmission occasion for signaling from the AIoT device to accommodate the processing criterion, such as the expected service processing time, of the AIoT device. The AIOTF can determine that the expected AIoT service processing time at the AIoT device may be increased based on information received from another network function (e.g., an application function (AF) or an ADM function), or by analysis of previous communication patterns.

The other network function may have prior knowledge of one or more capabilities of the AIoT device or may have observed patterns in the operation of the AIoT device that indicate longer processing criterion. For example, an ADM may maintain data of AIoT devices, including AIoT device profile data, which include information about energy harvesting capabilities of the AIoT devices and processing criterion of the AIoT devices. The AF may include an indication in an AIoT service request message that the expected service processing time for command processing at the AIoT device may be increased, an approximate time value indicating the expected service processing time, information about the energy storage capacity of the AIoT device, or details about radio coverage conditions that may impact energy harvesting efficiency.

Additionally, or alternatively, the AIOTF determines that the processing time of the AIoT service operation at the AIoT device is expected to exceed a threshold value based on failing to receive a command response or based on receiving an indication of a failure of the command request transmissions to the AIoT device. The AIOTF infers the extended processing time based on observed communication failures. If an AIoT device consistently fails to respond within standard timeframes (e.g., greater than a threshold number of times), then the AIOTF can adapt by extending the processing time for future communications. The AIOTF can determine the extended service processing time internally or locally according to a size of the R2D message (e.g., for a write command operation) or based on an expected size of the D2R message (e.g., for a read command operation). For example, the larger the size of the data or information to process is, the longer the expected service processing time at the AIoT device. The AIOTF may have preconfigured or predetermined threshold values for the length of a NAS command request or response messages. If the threshold values are exceeded, then the AIOTF may determine to increase the processing time.

The AIOTF may receive an indication (e.g., feedback) from the reader device that the AIoT device has not sent a D2R message in the assigned uplink occasion. The feedback provides for the AIOTF to detect when an AIoT device is unable to respond within the initially allocated transmission occasion, such as due to insufficient energy or extended processing criterion. Upon receiving the indication, the AIOTF can initiate adjustment of the transmission window to accommodate the expected service processing time of the AIoT device in subsequent communication attempts. For example, a next generation application protocol (NGAP) reply message sent to the AIOTF may include a NGAP correlation ID and an indication about a failure, which may indicate that there was no response message received from the AIoT device, or that the response message transmission was not successful. The failure indication may also provide additional context about the nature of the failure, such as information about the energy status of the AIoT device or processing capabilities of the AIoT device.

After determining that the AIoT device is expected to utilize an extended processing time, the AIOTF transmits an AIoT service request message (e.g., command request) to a reader device, including an indication about the expected service processing time. The AIoT service request message enables the reader device to adjust one or more communication parameters of a reader device, accordingly, such as by extending a duration of a transmission occasion during which the reader device expects to receive a response from the AIoT device. By communicating the information to the reader device, the AIOTF enables the reader device and the AIoT device to accommodate the processing criterion of the AIoT device. Based on the extended processing time, the reader device determines a value for the transmission occasion of the uplink transmission (e.g., the D2R occasion for a D2R message). The time period between the reception of the R2D message and the transmission of the D2R message may be referred to as Toffset. The reader device assigns a larger period for the D2R occasion to the AIoT device, providing the AIoT device with sufficient time to process the command and generate a response.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include an NE 102-a, which may be an example of an NE 102 as described with reference to FIG. 1. The NE 102-a may communicate with an AIoT device 202 directly via a wireless communications link 204. For example, the NE 102-a may transmit signaling to the AIoT device 202 via the wireless communications link 204, which is referred to as R2D signaling or messages. In some other examples, the AIoT device 202 may transmit signaling to the NE 102-a via the wireless communications link 204, which is referred to as D2R signaling or messages.

In some cases, a NE 102-a may be a reader device that communicates directly with an AIoT device 202 through a wireless communications link 204. For example, the NE 102-a can send AIoT signaling 206 directly to the AIoT device 202, enabling efficient transmission of command requests and reception of command responses without utilizing intermediary devices. As a reader device, the NE 102-a is capable of transmitting radio frequency signaling that can both power the AIoT device 202 and configure the AIoT device 202 to transmit a response within a transmission occasion. The NE 102-a may communicate with an AIOTF implemented at a CN through backhaul links, providing for the reader device to receive command requests related to AIoT communications with the AIoT device 202 from the network and report command responses back to the network.

FIG. 3 illustrates an example of a wireless communications system 300 in accordance with aspects of the present disclosure. In some examples, the wireless communications system 300 implements or is implemented by aspects of the wireless communications system 100 and the wireless communications system 200. For example, the wireless communications system 300 may include an NE 102-b and a UE 104-a, which may be an example of an NE 102 and a UE 104, respectively, as described with reference to FIG. 1. The NE 102-a may communicate with an AIoT device 302 indirectly via the UE 104-a. The NE 102-a and the UE 104-a may exchange (e.g., transmit, receive) signaling via a wireless communications link 304, which may be an example of a Uu wireless communications link. The UE 104-a and the AIoT device 302 may exchange (e.g., transmit, receive) signaling via a wireless communications link 306. For example, the UE 104-a may transmit signaling to the AIoT device 302 via the wireless communications link 306, which is referred to as R2D signaling or messages. In some other examples, the AIoT device 302 may transmit signaling to the UE 104-a via the wireless communications link 306, which is referred to as D2R signaling or messages. The UE 104-a may forward messages between the NE 102-b and the AIoT device 302.

In some cases, a UE 104-a may act as an intermediary reader device that facilitates communication between an NE 102-b and an AIoT device 302 through the wireless communications link 304 and the wireless communications link 306. The UE 104-a acting as an intermediary reader device may extend the coverage range of the network, enable communication with AIoT devices in areas with reduced direct network connectivity, and potentially reduce power consumption for both the NE 102-b and the AIoT device 302 by facilitating shorter-range transmissions. The UE 104-a can receive AIoT signaling 308 from the NE 102-b via the wireless communications link 304 and forward the AIoT signaling 308 to the AIoT device 302 via the wireless communications link 306. As an intermediary reader device, the UE 104-a may be capable of relaying radio frequency signaling from the NE 102-b to power the AIoT device 302 and configuring the AIoT device to transmit a response within a transmission occasion. The NE 102-b may communicate with an AIOTF implemented at a CN through backhaul links, providing for the network to send command requests and receive command responses related to AIoT communications, which are then relayed through the UE 104-a to the AIoT device 302.

FIG. 4 illustrates an example of a network architecture 400 in accordance with aspects of the present disclosure. In some examples, the network architecture 400 implements or is implemented by aspects of the wireless communications system 100 and the wireless communications system 200. For example, the network architecture 400 may include an AIoT device 402, which may be an example of the AIoT device 202 as described with reference to FIG. 2. The network architecture 400 may include one or more network functions for managing AIoT communications between the AIoT device 402 and an NE directly.

The network architecture 400 may include several network functions and reference points (e.g., interfaces) that facilitate AIoT communications. A reference point may refer to a logical interface or connection between two network functions or entities that enables the exchange of information, signaling, or data for AIoT communications. The AIoT device 402 may communicate with an AIoT RAN 404 via an AIOT1 reference point, which may be used for transmitting AIoT data and signaling between the AIoT device and the network. The AIoT RAN 404 may connect to an AIOTF 406 via an AIOT2 reference point, enabling the exchange of AIoT control information and data. The AIOTF 406 may serve as a central entity for managing AIoT services, including inventory and command operations. The AIOTF 406 may interact with an ADM function 408 via an AIOT6 reference point. The ADM function 408 may store and manage AIoT device profiles, including information about device capabilities, energy harvesting characteristics, and processing criterion, among other information. The AIOTF 406 may communicate with an NEF and/or an AF, such as the NEF/AF 410, via an AIOT4 reference point, which may represent an entry point for external applications to access AIoT services. The various network functions and interfaces in the network architecture 400 may enable adaptive timing management for AIoT communications. For example, the AIOTF 406 may receive information about extended processing times from the ADM function 408 or NEF/AF 410, process the information, and then communicate timing parameters to the AIoT RAN 404. The AIoT RAN 404 may configure the transmission occasions for the AIoT device 402.

For a direct path or direct connectivity between the AIoT device and the network (e.g., an NE), as described with reference to FIG. 2, the AIOTF communicates directly with an AIoT RAN 404 via the AIOT2 reference point to perform AIoT operations. For an indirect path or indirect connectivity between the AIoT device and the network (e.g., via a UE), as described with reference to FIG. 3, the AIOTF communicates directly with an AIoT RAN via the AMF, wherein the interface or reference point between the AIOTF and the AMF is referred to as AIOT3, which is described in further detail with respect to FIG. 5. In both direct path and indirect path connectivity, the AIoT device 402 and AIOTF 406 exchange signaling via AIOT1. The AIOT1 reference point or interface is used to transfer AIoT data (e.g., data to be written to the AIoT device 402 or read from the AIoT device 402) between an AIoT device 402 and AIOTF 406. The AIOTF 406 is a CN function that supports AIoT services (e.g., inventory and/or command). The AIOTF 406 selects one or more AIoT RAN nodes. An AIoT RAN node supports one or more NEs as reader devices, and one NE reader device serves a defined service area within the AIoT RAN 404. The AIOTF 406 receives an AIoT service request from the AF and triggers the AIoT RAN node to perform AIoT service operations towards one or more targeted AIoT devices. The AF is the AIoT service consumer.

The ADM function 408 is responsible for the management of AIoT device profile data. The ADM function 408 may be similar to a unified data management (UDM) and/or unified data repository (UDR) function, where the UE data profiles and subscription data is stored. The ADM function 408 manages and stores profiles of AIoT devices, including one or more of an AIoT device permanent ID, corresponding credentials, or a last known location, among other examples. The AIOTF 406 exchanges signaling with the ADM function 408 via the AIOT6 reference point. Any AIoT application can send and receive AIoT data to the AIOTF 406 via the AIOT4 reference point. For an AF that is not trusted, the AF exchanges signaling with the NEF and the NEF forwards the signaling to the AIOTF 406.

A globally unique AIoT device permanent ID is allocated to each AIoT device by an operator or by a third party. The AIoT device permanent ID identifies the AIoT device and locates where the AIoT device information is stored. The network architecture 400 (e.g., a 5GS) may support AIoT inventory service for discovering AIoT devices and AIoT command service for performing operations. The operations include read operations to retrieve information from AIoT devices, write operations to write information to the AIoT devices, and disable operations to permanently disable a capability of the AIoT devices to transmit radio frequency signals.

FIG. 5 illustrates an example of a network architecture 500 in accordance with aspects of the present disclosure. In some examples, the network architecture 500 implements or is implemented by aspects of the wireless communications system 100 and the wireless communications system 300. For example, the network architecture 500 may include an AIoT device 502, which may be an example of the AIoT device 302 as described with reference to FIG. 3. The network architecture 500 may include one or more network functions for managing AIoT communications between the AIoT device 502 and an NE indirectly via a UE.

The network architecture 500 may include several network functions and reference points (e.g., interfaces) that facilitate indirect AIoT communications via a UE. The AIoT device 502 may communicate with an AIoT RAN 504 via an AIOT1 reference point, which may be used for transmitting AIoT data and signaling between the AIoT device and the network. The AIoT RAN 504 may connect to an AMF 506 via an N2 interface, enabling the exchange of control plane information. The AMF 506 may serve as a mobility management entity and may connect to an AIOTF 508 via an AIOT3 reference point, facilitating the transfer of AIoT control information. The AIOTF 508 may act as a central entity for managing AIoT services, including inventory and command operations in scenarios involving indirect communication. The AIOTF 508 may interact with an ADM function 510 via an AIOT6 reference point, which may store and manage AIoT device profiles, including information about device capabilities, energy harvesting characteristics, and processing criterion, among other information. The AIOTF 508 may communicate with an NEF and/or an AF, such as the NEF/AF 512, via an AIOT4 reference point, which may represent an entry point for external applications to access AIoT services in indirect communication scenarios.

The various network functions and reference points in the network architecture 500 may enable adaptive timing management for indirect AIoT communications. For example, the AIOTF 508 may receive information about extended processing times from the ADM function 510 or NEF/AF 512, process the information, and then communicate timing parameters to the AIoT RAN 504 via the AMF 506. The AIoT RAN 504 may configure the transmission occasions for the AIoT device 502, accounting for the additional latency introduced by the indirect communication path through the UE.

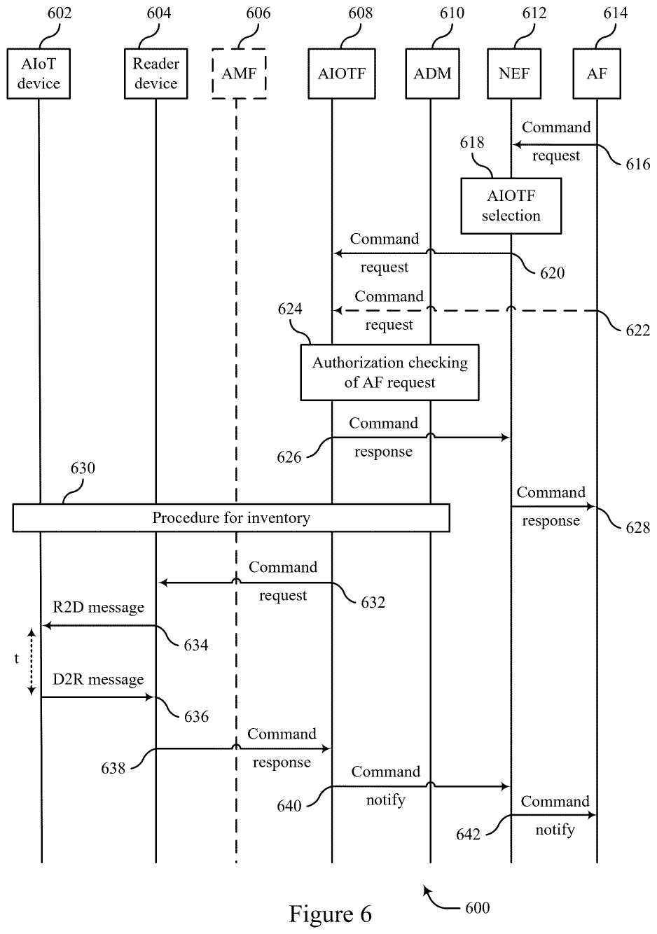

FIG. 6 illustrates an example of a signaling diagram 600 in accordance with aspects of the present disclosure. In some examples, the signaling diagram 600 implements or is implemented by aspects of the wireless communications system 100, the wireless communications system 200, the wireless communications system 300, the network architecture 400, and the network architecture 500. The signaling diagram 600 may implement or be implemented by one or more devices (e.g., NEs, UEs, reader devices, AIoT devices, and/or network entities including or implementing network functions), including an AIoT device 602, a reader device 604, an AMF 606, an AIOTF 608, an ADM function 610, an NEF 612, and an AF 614, which may be examples of the corresponding devices and functions as described with reference to FIGS. 1 through 5. For example, the signaling diagram 600 may illustrate an example of a command service for AIoT communication. Alternative examples of the following may be implemented, where some processes are performed in a different order than described or are not performed. In some cases, processes may include additional features not mentioned below, or further processes may be added.

A network entity may refer to any device or component within a wireless communications system that participates in network operations, such as a base station, a CN, or a dedicated AIoT server. For example, a CN may implement an AIOTF 608 to manage AIoT services and coordinate communications between AIoT devices and other network components. In some cases, a network entity, such as an edge server, may implement an NEF 612 to provide a secure interface for external applications to access AIoT services. Additionally, or alternatively, a dedicated AIoT management server may implement an ADM function 610 to store and manage AIoT device profiles and related information. The network entities may work together to enable efficient AIoT communications by implementing various network functions that handle tasks, such as device discovery, command processing, and adaptive timing management.

At 616, the AF 614 sends a command request to the NEF 612. The command request initiates an AIoT command procedure. An AIoT command procedure may refer to a sequence of operations and message exchanges between network entities and AIoT devices to execute one or more tasks, such as reading data from or writing data to AIoT devices. The AF 614 may use an Nnef_AIoT_Command service request operation for an AF 614 that is not trusted (e.g., untrusted). For a trusted AF 614, the AF 614 may use an Naiotf_AIoT_Command service request operation to send a command to the AIOTF 608. The AF 614 includes at least one parameter in the request message. The at least one parameter includes, but is not limited to, an AF ID (e.g., identifying the AF 614), a command type, information about one or more target AIoT devices, or external target area information or command type specific parameters, among other examples. The command type parameters may be related to the parameters utilized for the operation, such as an address of user memory (e.g., the offset to read and/or write application data from, the length of the application data to read and/or write). The application data may be from the user memory in the place indicated by the offset and the length.

At 618, the NEF 612 performs AIOTF selection to determine an AIOTF 608 to handle the command request. The AIOTF selection process may involve evaluating various factors to determine the AIOTF 608 to handle the command request. For example, the NEF 612 may consider a geographical location of target AIoT devices, a current load on different AIOTFs, and capabilities for the requested command type. In some cases, the NEF 612 may utilize a load balancing algorithm to distribute requests across multiple AIOTFs, ensuring efficient resource utilization and performance for AIoT operations.

At 620, the NEF 612 forwards the command request to the selected AIOTF 608.

At 622, the AIOTF 608 may retrieve AIoT device context information from the ADM function 610. For example, the AIOTF 608 may retrieve AIoT device context information from the ADM function 610 to obtain device parameters of the AIoT device 602, such as energy harvesting capabilities, processing power, or last known location. The AIOTF 608 may retrieve the AIoT device context information for AIoT devices that have varying capabilities or if the command request includes various execution options for current state or historical data related to the AIoT device 602. The context information may include, but is not limited to, device IDs (e.g., AIoT device permanent ID), energy harvesting capabilities and current energy status, processing power and available computational resources, last known location or geographical coordinates, network connectivity status and signal strength, battery level or power source information, supported communication protocols and interfaces, firmware version and update history, sensor types and capabilities, data storage capacity and current usage, security credentials and authentication status, operating mode (e.g., active, sleep, low-power), historical data on command execution times, device type and manufacturer information, environmental conditions (e.g., temperature, humidity) if applicable, time since last successful communication, scheduled maintenance or update information, associated user or owner information, device configuration settings, quality of service (QoS) criterion, and supported AIoT services and operations.

At 624, the AIOTF 608 performs authorization of the AF 614 request to determine that the AF 614 has permission to issue the command. The authorization process may include verifying credentials and access rights of the AF 614 and determining that the requested command aligns with one or more configured or predefined policies for AIoT device interactions. In some cases, the AIOTF 608 may authorize the request if the AF 614 has the permissions for the AIoT device 602 or command type, while denying authorization if the AF 614 lacks sufficient privileges or if the requested operation exceeds defined security thresholds. The AIOTF 608 may also determine a sensitivity of the data being accessed, the impact of the command on the operation of the AIoT device 602, and/or any temporal or geographical criterion associated with the permission of the AF 614 when determining whether to authorize the request from the AF 614.

At 626 and at 628, command responses are sent back through the NEF 612 to the AF 614 to confirm the request is authorized. For example, the AIOTF 608 may send a command response to the NEF 612, which then forwards the response to the AF 614. For example, the command response may include an authorization status code, as well as relevant details about the authorization determination.

At 630, a procedure for inventory is performed. The inventory procedure is a process used to discover and identify AIoT devices within a defined area or network. The inventory procedure may include broadcasting inventory request signals, collecting responses from AIoT devices, and updating a database with the gathered device information. For example, the inventory procedure includes the AIOTF 608 selecting a reader device 604 for a target area, the AIOTF 608 sending an inventory request message to the selected reader device 604, the reader device 604 broadcasting an inventory request signal to AIoT devices in the coverage area, the AIoT devices responding with inventory response messages including AIoT device IDs, the reader device 604 collecting the responses and forwarding the responses to the AIOTF 608, and the AIOTF 608 updating the inventory database with the collected AIoT device information. The inventory procedure may be performed during initial network setup when deploying a new AIoT network or expanding an existing AIoT network, where the inventory procedure may be used to identify and register newly added devices. The inventory procedure may also be used for device discovery in cases where the network is locating defined AIoT devices or determining which AIoT devices are currently active within a given area. In some cases, the inventory procedure may be performed automatically at regular intervals or triggered by events to maintain an accurate and current view of the AIoT devices within the network.

At 632, the AIOTF 608 sends a command request to the AMF 606. For example, the command request may include one or more parameters, such as a command ID, target AIoT device information, command type, payload data, timing criterion, priority level, security tokens, and any execution instructions for the AIoT device 602.

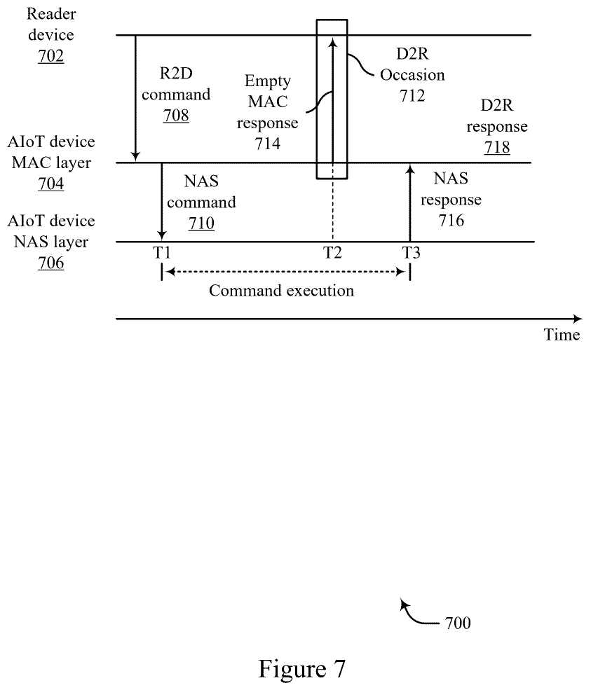

At 634, the reader device 604 sends an R2D message to the AIoT device 602. The reader device 604 assigns a time slot (e.g., transmission occasion, D2R occasion) to the AIoT device 602 for a D2R message transmission. If the AIoT device 602 is not able to generate the reply message in the assigned D2R occasion, then the AIoT device 602 may miss the occasion and the D2R message reply may be available for transmission after the scheduled time slot. The AIoT device 602 is unable to transmit the D2R message due to longer processing time, which is described in further detail with respect to FIG. 7. For example, the AIoT device 602 may not be able to execute the command in time due to one of the read or write message exceeding a threshold size or length (e.g., utilizing longer time for execution) or the AIoT device 602 energy being below a threshold value, resulting in slow command operation execution.

At 636, the AIoT device 602 sends a D2R message back to the reader device 604 if a processing time, t, does not exceed a threshold value (e.g., a duration of the transmission occasion).

At 638, the reader device 604 sends a command response to the AMF 606. For example, the command response message may include information, such as the command execution status, data retrieved or modified during the operation, timestamps, and performance metrics related to the command execution on the AIoT device 602.

At 640 and at 642, command notify messages are sent from the AMF 606 to the AIOTF 608 and then to the NEF 612. For example, the command notify messages may include information, such as a command execution status, AIoT device IDs, retrieved data, execution timestamps, and error codes or performance metrics. The command notify messages may propagate through the network to inform relevant entities about the command outcome. In some cases, the notify messages may include additional details, such as energy consumption data, signal quality indicators, or updated device status information. For example, a notify message may include details about the successful execution of an AIoT command, providing for the NEF 612 to update records and inform the AF 614 about the outcome of the operation.

FIG. 7 illustrates an example of a signaling diagram 700 in accordance with aspects of the present disclosure. In some examples, the signaling diagram 700 implements or is implemented by aspects of the wireless communications system 100, the wireless communications system 200, the wireless communications system 300, the network architecture 400, the network architecture 500, and the signaling diagram 600. The signaling diagram 700 may implement or be implemented by one or more devices (e.g., NEs, UEs, reader devices, AIoT devices, and/or network entities including or implementing network functions), including a reader device 702 and an AIoT device, which may be examples of the corresponding devices and functions as described with reference to FIGS. 1 through 6. For example, the signaling diagram 700 may illustrate an example of a command service for AIoT communication. Alternative examples of the following may be implemented, where some processes are performed in a different order than described or are not performed. In some cases, processes may include additional features not mentioned below, or further processes may be added.

The signaling diagram 700 includes the reader device 702 and the AIoT device, which is represented by an AIoT device MAC layer 704 and an AIoT device NAS layer 706. In some cases, the AIoT device may include multiple protocol layers to handle different aspects of communication. The AIoT device MAC layer 704 may manage access to a shared wireless medium, including managing frame formatting, addressing, and error detection. The AIoT device NAS layer 706 may manage higher level functions, including session management, mobility management, and application level communication. The layers may work in conjunction to process incoming messages and generate responses. The reader device 702 may communicate directly with the AIoT device MAC layer 704, which may relay relevant information to and from the AIoT device NAS layer 706. The layered architecture may provide for efficient handling of different types of signaling and data, with the AIoT device MAC layer 704 managing the physical transmission and reception of messages and the AIoT device NAS layer 706 processing the content of the messages.

The reader device 702 transmits an AS R2D command message over a radio interface. For example, the reader device 702 transmits an R2D command 708 to the AIoT device MAC layer 704. The AIoT device MAC layer 704 forwards (e.g., transmits, sends, outputs, relays) the R2D command 708 to the AIoT device NAS layer 706 as a NAS command 710 at a time T1. The AS R2D command message may include a NAS payload (e.g., a NAS command 710) and additional information, such as a D2R occasion 712 that occurs at time T2. The AIoT device NAS layer 706 receives the NAS command 710 at the time T1. The AIoT device has a duration, referred to as a command execution duration, between T1 and a time T3 for execution of the command. Due to various conditions, the command execution may take longer than the D2R occasion 712 at the time T2. The D2R occasion 712 may include an empty MAC response 714. For example, the AIoT device may be ready with the NAS response 716 at the time T3, which is after the time T2. The AIoT device MAC layer 704 may not be able to transmit the NAS response 716 and the corresponding D2R response 718, resulting in a transmission failure (e.g., transmission of the empty MAC response 714), although the AIoT device may have successfully completed the command.

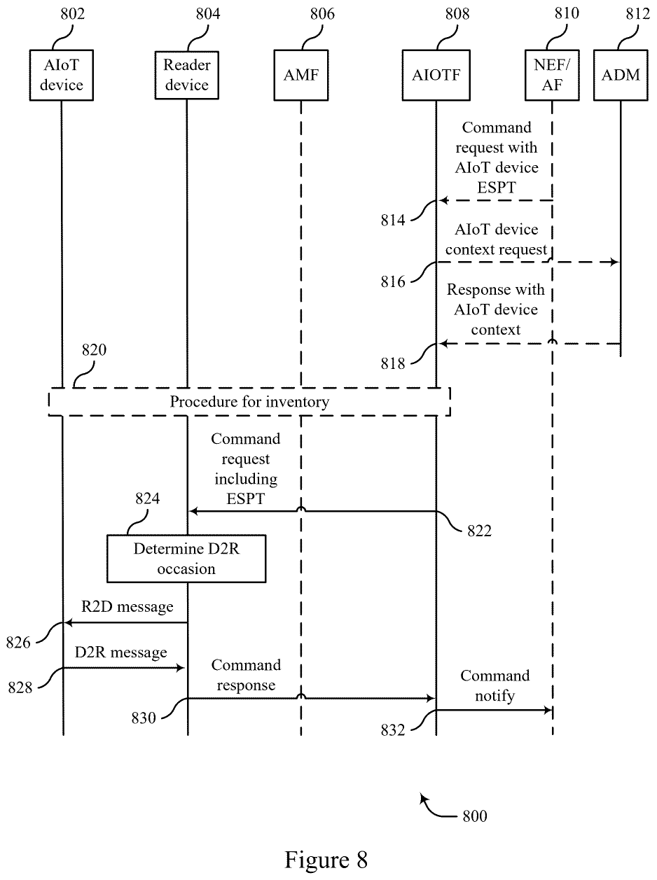

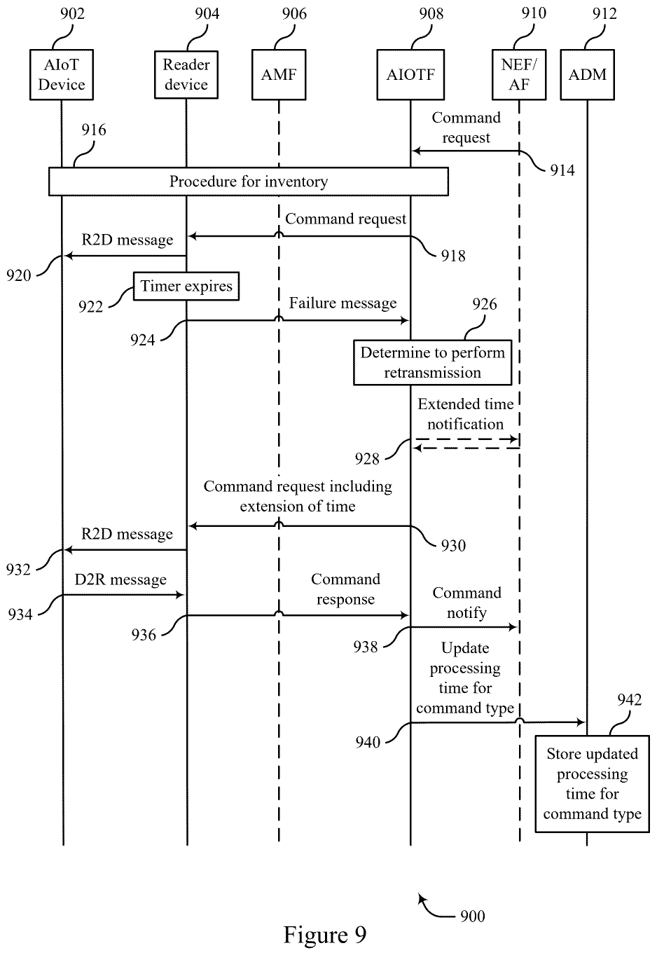

To proactively prevent failures in D2R message transmissions, an AIOTF and the reader device 702 may adaptively configure transmission occasions based on expected service processing times, which is described in further detail with respect to FIG. 8. Additionally, or alternatively, if a transmission failure has already occurred, an AIOTF and the reader device 702 may implement retransmission mechanisms that accommodate the extended processing criterion of AIoT devices, which is described in further detail with respect to FIG. 9. Thus, AIoT devices with reduced energy storage capabilities may successfully complete command operations despite longer processing times, thereby improving communication reliability and reducing signaling overhead. The techniques provide for network entities to dynamically adjust transmission windows based on device capabilities, energy harvesting conditions, and command complexity, ensuring that AIoT devices have sufficient time to process commands and generate responses regardless of operational conditions.

FIG. 8 illustrates an example of a signaling diagram 800 in accordance with aspects of the present disclosure. In some examples, the signaling diagram 800 implements or is implemented by aspects of the wireless communications system 100, the wireless communications system 200, the wireless communications system 300, the network architecture 400, the network architecture 500, the signaling diagram 600, and the signaling diagram 700. The signaling diagram 800 may implement or be implemented by one or more devices (e.g., NEs, UEs, reader devices, AIoT devices, and/or network entities including or implementing network functions), including an AIoT device 802, a reader device 804, an AMF 806, an AIOTF 808, an NEF/AF 810, and an ADM function 812, which may be examples of the corresponding devices and functions as described with reference to FIGS. 1 through 7. For example, the signaling diagram 800 may illustrate an example of adaptively configuring transmission occasions based on expected service processing times. Alternative examples of the following may be implemented, where some processes are performed in a different order than described or are not performed. In some cases, processes may include additional features not mentioned below, or further processes may be added.

In some cases, an owner or operator of an AIoT device (e.g., the AIoT device 802) may be aware that the AIoT device may utilize a longer time to process an AIoT service operation (e.g., an AIoT command operation). The longer time may result from various factors, including but not limited to, a device capability to store less energy, device installation in poor radio coverage conditions, complexity of the requested operation, size of data to be processed, or hardware criterion of the AIoT device 802. The factors may impact an ability of the device to respond within standard timing parameters.

The AIOTF 808 determines (e.g., receives a notification from an NEF/AF 810 or internally determines) that an expected AIoT service (e.g., command) processing time (e.g., an ESPT) at the AIoT device 802 may be increased. In other words, the AIOTF 808 determines that the processing time of an AIoT service operation may be increased beyond one or more configured threshold values or standard parameters.

In some cases, the AIOTF 808 receives an indication of an expected service processing time from another network function (e.g., an ADM function 812 or an NEF/AF 810). The indication may include one or more timing parameters, device capability information, or environmental factors affecting processing time. The indication may be provided as part of a command request message or through a separate notification mechanism designed for communicating processing time criterion.

In some other cases, the AIOTF 808 can internally determine the increased processing time due to previous non-reception of command response or failure of the command request transmissions to the AIoT device 802. The AIOTF 808 can determine the expected service processing time internally and/or locally based on a size of the message received from the AF (e.g., the R2D message in the AS for a write command operation) or based on an expected size of the D2R message (e.g., for a read command operation). For example, the larger the data or information to process, the longer the expected service processing time at the AIoT device 802. Additionally, or alternatively, the AIOTF 808 may analyze historical performance data for similar operations with the same AIoT device 802 or devices with similar capabilities to estimate processing time criterion of the AIoT device 802. The AIOTF 808 may also determine the processing time criterion of the AIoT device 802 using current network conditions, signal quality metrics, and known energy harvesting capabilities of the AIoT device 802.

The AIOTF 808 sends an indication to the reader device 804 about the expected service processing time (e.g., the ESPT). The indication may include at least one of a potentially expected increased processing time at the AIoT device 802 with a corresponding expected time value or the AIoT service (e.g., command) request message is a retransmission of command message, which may have resulted from non-reception of previous command response message or due to failure of message transmission. The indication may also include information about the battery storage capability of the AIoT device 802, energy harvesting capability of the AIoT device 802, or signal quality between the AIoT device 802 and the reader device 804, which may affect the processing time criterion. The information enables the reader device 804 to determine a duration of a transmission occasion for a transmission from the AIoT device 802 (e.g., a D2R message).

The battery storage capability of the AIoT device 802 may refer to a capacity to store and retain electrical energy for operation, which may impact an ability of the AIoT device 802 to process commands and respond within timeframes. For example, an AIoT device 802 with a relatively low battery storage capability (e.g., less than a threshold battery storage) may utilize more frequent energy harvesting cycles, potentially leading to longer processing times for complex operations. Energy harvesting capability of the AIoT device 802 may include an ability of the AIoT device 802 to collect and convert ambient energy sources into usable electrical power, which may affect operational longevity and responsiveness of the AIoT device 802. For example, an AIoT device 802 with enhanced energy harvesting capabilities from radio frequency signals may maintain more consistent processing times (e.g., even in geographic areas with poor direct network connectivity). Signal quality between the AIoT device 802 and the reader device 804 may include strength and reliability of the wireless communications link between the two devices, which may influence the efficiency of data exchange and command execution. For example, if the signal quality is less than a threshold value, then the AIoT device 802 may utilize additional time to accurately receive and process commands, leading to longer transmission occasions.

Based on the received expected service processing time indication, the reader device 804 determines to assign to the AIoT device 802 a greater time period or duration for the D2R occasion, which may also be referred to as a transmission occasion or time slot. The determination may include calculating a duration for the transmission occasion that accommodates the expected service processing time, while balancing network resource utilization. The reader device 804 may apply different algorithms or formulas to calculate the duration based on the parameters received in the expected service processing time indication. For example, the reader device 804 may multiply the standard transmission occasion duration by a factor derived from the expected service processing time, or the reader device may add a fixed buffer time to ensure successful command completion.

In some examples, the AIOTF 808 receives an indication of an expected service processing time from another network function (e.g., the ADM function 812 or the NEF/AF 810), rather than being determined internally by the AIOTF 808. For example, at 814, the AIOTF 808 may receive a command request with an expected service processing time of the AIoT device 802 from an AF and/or from an NEF (e.g., the NEF/AF 810). The command request may include an AIoT service request message for transmission to the AIoT device 802. Although the AIoT device 802 is illustrated as a single AIoT device, the AIoT device 802 may include any numerical quantity of AIoT devices. The request message may indicate at least one of that the expected service processing time for the command processing at the device may be increased, an approximate time value may be included indicating the expected time for processing at the AIoT device 802, that the AIoT device 802 has a reduced capability of storing less energy capacity (e.g., resulting in longer processing time), or that the AIoT device 802 is located at a position having poor radio coverage from the radio signals transmitted by the reader device 804. The poor radio coverage condition may result in less energy from the carrier wave received from the reader device 804 and increased processing time at the AIoT device 802.

The AIOTF 808 may offer an Niotf_AIoT_Command service to the NEF/AF 810. The command request message may include one or more parameters, such as an AF ID, external target area information in which one or more AIoT devices may be located, and information about target AIoT devices (e.g., AIoT identification information or AIoT device permanent IDs), among other examples. The AIoT identification information can include, but is not limited to, device type IDs, manufacturer codes, serial numbers, network addresses, international mobile equipment identities (IMEIs), MAC addresses, or any combination thereof that may uniquely identify or categorize the AIoT devices within the network. The AIOTF 808 may authorize the command request to determine whether the AF is eligible to use the requested network services or whether to use the service to the target AIoT device 802.

If the AF is a trusted AF and the AF is configured to directly discover, select, and contact the AIOTF 808, then the trusted AF may send the request message for inventory directly to the AIOTF 808 at 814. If the AF is not trusted (e.g., untrusted), or if the AF is not able to select an AIOTF 808, then the AF may use the NEF exposed services and send the request message to the NEF, which then forwards the request to the AIOTF 808 at 814. That is, a trust relationship between the AF and the network functions determines the communication path for the expected service processing time indication.

The AIOTF 808 receives a request for command transmission from NEF/AF 810 at 814, which may not include an indication of an increased expected service processing time for the command procedure. In some cases, at 816, the AIOTF 808 may send a request to retrieve AIoT device profile or context data from a profile repository entity (e.g., the ADM function 812). The AIoT device profile is identified by an AIoT device permanent ID, and the profile may include an AIoT device temporary ID. For example, the AIOTF 808 may invoke an Nadm_DM_Query request service operation and include one or more AIoT device permanent IDs.

At 818, the ADM function 812 may respond with the AIoT device context data. For example, the ADM function 812 may use the service operation Nadm_DM_Query response and include one or more parameters, such as an AIoT device permanent ID, device temporary ID, cryptographic nonce information from the network (e.g., Nonce_nw), an AIoT device context, and AF service authorization data, among other examples. The exchange of AIoT device context data enables the AIOTF 808 to access current device profile information, which may include processing time information. For example, the AIOTF 808 determines processing time information by analyzing device capability, energy profile, historical performance, signal quality, operation complexity, adaptive learning algorithms, environmental factors, and/or network congestion, among other data retrieved from the ADM function 812. The AIOTF 808 may determine processing time for different types of AIoT service operations, including for devices with reduced computational resources or energy constraints that utilize extended processing times to complete operations.

The AIoT device profile stored by the ADM function 812 may include information that indicates an expected service processing time for the command exceeds a threshold value, or an approximate time value may be included. The information may indicate at least one of that the expected service processing time for the command processing at the device may be increased, an approximate time value may be included indicating the expected time for processing at the AIoT device 802, that the AIoT device 802 has a reduced capability of storing less energy capacity (e.g., resulting in longer processing time), or that the AIoT device 802 is located at a position having poor radio coverage from the radio signals transmitted by the reader device 804. Additionally, or alternatively, the AIoT device profile may include historical data about previous command execution times, energy consumption patterns, and other metrics that can be utilized to predict processing time criterion for different types of commands.

The information about the expected service processing time (e.g., or an approximate time value) for the command procedure may be provided in the AIoT device profile store by the ADM function 812. For example, an operations, administration, and maintenance (OAM) system of the communication network may be aware from the service level agreement (SLA) that an AIoT device 802 may utilize longer processing time. The OAM system may configure the AIoT device profile to include an indication of the longer processing time, providing for network operators to proactively configure timing parameters based on known device capabilities.

The AF may provision or update the AIoT device profiles directly at the ADM function 812. The AF may provision the corresponding information that the AIoT device may utilize longer processing time in the AIoT device profile, providing for application developers with knowledge of device capabilities to configure timing parameters.

In some cases, at 820, if the AIOTF 808 is not aware of the location and availability of the AIoT device 802, then the AIOTF 808 may perform an inventory procedure, as described with reference to FIG. 6. The inventory procedure enables the AIOTF 808 to identify the current location and status of AIoT devices before attempting command operations.

The AIOTF 808 performs a reader device selection for the request received at 814. The AIOTF 808 may use a last serving reader device ID as available from the AIoT device profile or context information to assist with determining which reader devices to use for an AF request targeting for an AIoT device 802. The selection process enables the AIOTF 808 to select a reader device 804 based on proximity to the AIoT device 802, current load, and capability to support extended processing times.

At 822, the AIOTF 808 sends an AIoT service operation request message (e.g., command request message) to the selected reader device 804. The command request message may include one or more parameters, such as an NGAP correlation ID to identify a service operation between the reader device 804 and the AIOTF 808 for an AIoT device 802. The parameters may additionally, or alternatively, include an AIoT device ID (e.g., temporary ID), which the reader device 804 can use as a paging ID. The parameters may additionally, or alternatively, include a NAS command request container to be transmitted as payload of the AS R2D message. The parameters may additionally, or alternatively, include one or more parameters to be used in the reader device 804 to assist the transmission of the NAS command request message over the air to the AIoT device 802. The parameters may indicate increased time for processing at the AIoT device 802 and/or an expected time value for the processing at the AIoT device 802. The parameters may include timing values, multipliers for standard timing parameters, or indicators of device capability limitations that affect processing time.

The AIOTF 808 may determine that the expected AIoT service (e.g., command service) processing time at the AIoT device 802 may be increased based on the information received in the command request with the expected service processing time of the AIoT device. The expected service processing time for an AIoT device 802 may be denoted as ESPT in FIG. 8. The AIOTF 808 may also consider additional factors, such as the current network load, time of day, and priority of the requested operation, when determining an expected service processing time value.

The AIOTF 808 may transmit the AIoT service operation request message (e.g., command request message) directly to the reader device 804 or via an AMF 806 (e.g., if there is no direct interface between the AIOTF 808 and the reader device 804 and the AMF 806 is involved). The communication path depends on the network architecture and available interfaces between network functions.

The reader device 804 receives the AIoT service operation request message (e.g., AIoT command request message) from the AIOTF 808 or alternatively from the AMF 806 (e.g., if there is no direct interface between the AIOTF 808 and the reader device 804 and the AMF 806 is involved). At 824, the reader device 804 determines a D2R occasion (e.g., time slot, transmission occasion). For example, based on the received expected service processing time indication, the reader device 804 may determine a value for the D2R occasion of the uplink transmission. The time period between the reception of the R2D message and the transmission of the D2R message may be referred as Toffset. The Toffset may be equal to a difference between T2 and T1 from FIG. 7. The reader device 804 may apply various algorithms to calculate the Toffset value, such as multiplying a standard value by a factor derived from the expected service processing time indication, adding a fixed buffer time, or using a lookup table based on command type and device capabilities. The reader device 804 may also utilize current signal quality measurements when determining the appropriate transmission occasion duration.

The reader device 804 prepares the AS R2D message and calculates the AS parameters to be transmitted to the AIoT device 802. The AS R2D message includes a NAS command request message, received at 822. At 826, the reader device 804 transmits an R2D message to the AIoT device 802. That is, the reader device 804 performs a transmission of the AS R2D message to the AIoT device 802. The R2D message is a signaling transmission that initiates a command procedure at the AIoT device and provides both command data and energy for the AIoT device to process the command.

The AIoT device 802 processes the AS R2D message and forwards the NAS message (e.g., the command request message) to the NAS layer, as shown in the FIG. 7. The AIoT device 802 may process the command message successfully (e.g., the processing time is shorter that the assigned D2R association time). The AIoT device 802 prepares a NAS response (e.g., command response or inventory response) message. The NAS layer passes the NAS response message to the AS layer within the AIoT device 802.

At 828, the AIoT device 802 transmits the AS D2R message to the reader device 804. The signaling including the D2R message is transmitted during the transmission occasion that was determined at 824 based on the expected service processing time. The extended duration of the transmission occasion ensures that the AIoT device 802 has sufficient time to process the command and prepare a response, even with reduced energy storage capabilities or in poor radio conditions.

At 830, the reader device 804 transmits an AIoT service response message (e.g., command response message or inventory response message) to the AIOTF 808 directly or as a NGAP AIoT information via an AMF 806. The reader device 804 may use an Naiotf_AIoT Command notify service operation offered by the AIOTF 808. The AIoT service response message may include one or more parameters, such as a correlation ID, reader device ID, NAS response message (e.g., inventory or command response), or RAN AIoT device NGAP ID, among other examples. The response message may also include information about the actual processing time used by the AIoT device 802, which can be used to update stored AIoT context data by the ADM function 812 for future operations.

The AIOTF 808 determines the AIoT device context from the command response message (e.g., by the received RAN AIoT device NGAP ID) to ensure that the response is associated with the original request.

At 832, the AIOTF 808 sends a command notify message to the NEF/AF 810. For example, the AIOTF 808 reports the result of the AIoT service operation (e.g., command request operation) to the NEF/AF 810 by sending the Naiotf_AIoT_Command notify message. The command notify message may include a list of response information from one or more AIoT devices, which includes AIoT device IDs, AIoT data, and/or AF IDs, among other information. The AIOTF 808 may also update stored AIoT context data based on the processing time information gathered during this operation, which can be used to improve future command procedures for the same device or similar devices.

The processes described in the signaling diagram 800 can be applied for public networks (e.g., a public land mobile network (PLMN)) and/or for private network (e.g., a non-public network (NPN) or a standalone NPN (SNPN)). The features and processes described in the signaling diagram 800 can accommodate various network architectures and deployment scenarios. The AIOTF 808 is able to receive an indication (e.g., from the AF or within the AIoT device profile from ADM function 812) that the AIoT device 802 may be expected to utilize an extended time for AIoT service operation (e.g., command request) processing. Based on the indication, the AIOTF 808 may provide assistance information including an expected service processing time indication to the reader device 804 to assist with a determination of the D2R occasion or the Toffset time period. Such indication provides for the reader device 804 to assign a longer time period for the D2R occasion to enable the AIoT device 802 to successfully process the AIoT request, which reduces transmission failures and improves the reliability of communications with AIoT devices that have reduced energy storage capabilities or are deployed in challenging radio environments. By adapting the transmission occasion duration based on an expected service processing time criterion, a wireless communications system can accommodate a wider range of AIoT devices with varying capabilities, while maintaining efficient use of network resources.

FIG. 9 illustrates an example of a signaling diagram 900 in accordance with aspects of the present disclosure. In some examples, the signaling diagram 900 implements or is implemented by aspects of the wireless communications system 100, the wireless communications system 200, the wireless communications system 300, the network architecture 400, the network architecture 500, the signaling diagram 600, the signaling diagram 700, and the signaling diagram 800. The signaling diagram 900 may implement or be implemented by one or more devices (e.g., NEs, UEs, reader devices, AIoT devices, and/or network entities including or implementing network functions), including an AIoT device 902, a reader device 904, an AMF 906, an AIOTF 908, an NEF/AF 910, and an ADM function 912, which may be examples of the corresponding devices and functions as described with reference to FIGS. 1 through 8. For example, the signaling diagram 900 may illustrate an example of retransmission mechanisms that accommodate an extended processing criterion of an AIoT device 902. Alternative examples of the following may be implemented, where some processes are performed in a different order than described or are not performed. In some cases, processes may include additional features not mentioned below, or further processes may be added.

An AIOTF 908 may not receive an indication from an NEF/AF 910 or an ADM function 912 that indicates an expected service processing time for an AIoT device 902 prior to transmitting an R2D message to the AIoT device 902. The AIOTF 908 can autonomously (e.g., internally) determine that the AIoT device 902 may utilize a longer processing time based on observed communication patterns or failures. The network may adaptively respond to AIoT device processing criterion even when not explicitly configured with the information.

In some cases, the AIOTF 908 can determine an increased processing time for an AIoT device 902 due to previous non-reception of a command response or failure of a command request transmissions to the AIoT device 902. The AIOTF 908 can determine the expected service processing time (e.g., an ESPT) internally or locally according to a size of the R2D message (e.g., for a write command operation) or according to an expected size of a D2R message (e.g., for a read command operation). For example, the larger the data or information to process is, the longer the expected service processing time at the AIoT device 902. The AIOTF 908 may identify one or more defined or preconfigured threshold values for message sizes (e.g., of the R2D message or the D2R message) that trigger extended processing time accommodations.

At 914, the NEF/AF 910 may send an AIoT service request message (e.g., command request) to the AIOTF 908 for transmission to the AIoT device 902. The NEF/AF 910 may use the Niotf_AIoT_Command service request as exposed by the AIOTF 908. The AIoT service request message may include one or more parameters, such as an AF ID, external target area information in which the AIoT device 902 may be located, information about the target AIoT device (e.g., also referred to as AIoT ID information or AIoT device permanent IDs), and an expected maximum response time for the command response, among other parameters.

The maximum response time is an expected time to perform a command transmission operation (e.g., for which the AIOTF 908 can send command response back to the NEF/AF 910). The maximum response time parameter enables the AIOTF 908 to determine whether there is sufficient time for retransmission attempts prior to an overall operation times out. For example, the AIOTF 908 may use the maximum response time to determine whether to attempt retransmission or notify the NEF/AF 910 of a failure condition.

At 916, if the AIOTF 908 is not aware of the location and availability of the AIoT device 902, then the AIOTF 908 may perform an inventory procedure, which may be an example of the inventory procedure as described with reference to FIG. 6. The inventory procedure enables the AIOTF 908 to identify a current location and status of the AIoT device 902 before attempting command operations.

At 918, the AIOTF 908 sends a command request message to the reader device 904 via the AMF 906. The initial command request may not include an indication of an expected service processing time (e.g., since the AIOTF 908 has not yet determined that the AIoT device 902 is utilizing an extended processing time). The command request message includes one or more parameters, such as an NGAP correlation ID, AIoT device ID, and NAS command request container to be transmitted as a payload of an AS R2D message.

At 920, the reader device 904 transmits an R2D message to the AIoT device 902. The reader device 904 assigns to the AIoT device 902 a standard D2R occasion for the transmission of the AS D2R message, without any extension for increased processing time since no expected service processing time indication was received. The R2D message includes the command request that the AIoT device 902 is to process.

At 922, a timer expires at the reader device 904, indicating that the scheduled time for receiving the D2R message has elapsed (e.g., expired, passed) without receiving a response from the AIoT device 902. The timeout may occur do to the AIoT device 902 utilizing more processing time than was allocated in a D2R occasion. The AIoT device 902 may have received the R2D message and may have been unable to complete processing and generate a response within the allocated transmission occasion.

At 924, the reader device 904 sends a failure notification to the AIOTF 908 via the AMF 906. For example, the reader device 904 sends an NGAP reply message to the AIOTF 908 that includes an NGAP correlation ID and an indication about the failure. The failure indication indicates that there was no response message received from the AIoT device 902 during the scheduled transmission occasion. The notification serves as a trigger for the AIOTF 908 to evaluate whether the AIoT device 902 utilizes an extended processing time. The reader device 904 may include a time value that is used to configure the D2R transmission occasion in the reply message to the AIOTF 908. In other words, the reader device 904 indicates to the AIOTF 908 the time interval that was used to schedule the D2R transmission occasion at the AIoT device and was configured at 920.

At 926, the AIOTF 908 determines to perform a retransmission. The AIOTF 908 determines, based on the failure indication received from the reader device 904, that the AIoT device 902 utilizes an extended processing time. The AIOTF 908 analyzes the failure and determines to perform retransmission of the AIoT service request message with an adjusted transmission occasion duration (e.g., using the time interval for the last scheduled D2R transmission occasion if received at 924). The AIOTF 908 may determine an increased processing time at the AIoT device 902 due to the type of failure indication (e.g., non-reception of NAS command response) and the AIOTF 908 may determine an expected time to perform a command transmission operation at the AIoT device 902 (e.g., an expected service processing time at the AIoT device).

The AIOTF 908 can determine the expected service processing time indication based on the reception of the failure indication from the reader device 904, the time value (e.g., or time interval) indicated at 924 for the (e.g., failed) D2R transmission occasion scheduling at the AIoT device, and/or internal or local logic by considering the size or length of the R2D message (e.g., downlink NAS message like NAS command request) for a write command operation, based on the expected size or length of the D2R message (e.g., expected uplink NAS message like NAS Command Response) for a read command operation, and historical performance data for similar operations with the same AIoT device 902 or devices with similar capabilities, among other examples. For example, the larger the data or information to process at the device side is, the longer the expected service processing time is at the AIoT device 902. The AIOTF 908 may have a preconfigured or predetermined (e.g., determined by taking into account artificial intelligence/machine learning (AI/ML) functionality) threshold value for length of the NAS command request message or a threshold value for the length of the NAS command response message. If the threshold value is exceeded, then the AIOTF 908 may determine that the processing time at the AIoT device 902 is increased, and the expected service processing time indication is to be included in the request from the AIOTF 908 to the reader device 904. Additionally, or alternatively, the AIOTF 908 may internally measure the time duration between the transmission of the signaling at 918 and the reception of the response signaling at 924. For example, if a time interval between 918 and 924 or a time value (e.g., or time interval) indicated by the reader device 904 for the (e.g., failed) D2R transmission occasion indicated in signaling at 924 is X seconds (e.g., 10 seconds), then the AIOTF 908 may determine an extended service processing time indication including an expected time to perform a command transmission operation at the AIoT device 902 larger than the X seconds. In some examples, the AIOTF 908 may determine a recommended time value equal to twice the X seconds (e.g., twice 10 seconds equal to 20 seconds).

At 928, the AIOTF 908 sends an extended time notification to the NEF/AF 910 and receives a response that indicates whether there is sufficient time remaining within the maximum response time (e.g., received at 914) to perform a retransmission with extended processing time. If there is not enough time to perform the retransmission of the command message (e.g., the maximum response time is about to expire before a retransmission can be successful), then the AIOTF 908 may perform one of the following options. The AIOTF 908 may send a notification message to the NEF/AF 910 to indicate that the transmission of the command message as received at 914 takes longer time than expected (e.g., due to retransmission) and to indicate an expected transmission time to perform a command transmission or retransmission operation. The expected transmission time to perform the command transmission or retransmission may include an expected time to perform a command transmission operation at the AIoT device 902 and additional time to perform signaling at 930, 932, 934, 936 and 938. The notification may include an indication that the AIoT service (e.g., command operation) is to be extended. The AIOTF 908 may proceed with the retransmission as at 930. Additionally, or alternatively, the AIOTF 908 may send a notification to the NEF/AF 910 to indicate that the transmission of the command message as received at 914 has failed and to indicate the expected transmission time to perform a command transmission or retransmission operation. The NEF/AF 910 (e.g., application layer logic in the AF or application server) determines whether to send a new transmission of the command to the AIoT device 902. In some cases, the NEF/AF 910 may cancel the transmission of the AIoT message to the AIoT device 902. In some other cases, the NEF/AF 910 may perform a new transmission with a longer maximum response time in the request, providing for the NEF/AF 910 to reuse the parameter maximum response time with a higher value of the time based on the observed failure and considering the expected transmission time to perform a command transmission or retransmission operation.

At 930, the AIOTF 908 sends a command request message including extension of time to the reader device 904 via the AMF 906. The command request message may be similar to the command request at 918, but may include an expected service processing time indication based on the determination at 926. The expected service processing time indication informs the reader device 904 that the AIoT device 902 utilizes an extended processing time, and may include one or more parameters that indicate the expected duration.

At 932, the reader device 904 transmits a second R2D message to the AIoT device 902. Based on the received expected service processing time indication in the command request at 930, the reader device 904 determines a value for the D2R occasion of the uplink transmission. The time period between the reception of the R2D message and the transmission of the D2R message (e.g., Toffset) is extended compared to the previous attempt at 920. The reader device 904 prepares the AS R2D message and calculates the AS parameters to be transmitted to the AIoT device 902, including the extended D2R occasion timing.

At 934, the AIoT device 902 processes the AS R2D message and forwards the NAS message (e.g., the command request message) to the NAS layer. With the extended processing time allocation, the AIoT device 902 is able to successfully process the command message (e.g., the processing time is shorter than the assigned extended D2R occasion time). The AIoT device 902 prepares a NAS response (e.g., command response) message and transmits the AS D2R message to the reader device 904 within the extended transmission occasion.

At 936, the reader device 904 transmits a command response to the AIOTF 908 via the AMF 906. The reader device 904 may use an Naiotf_AIoT command notify service operation offered by the AIOTF 908. The command response message includes one or more parameters, such as the correlation ID, reader device ID, NAS response message (e.g., command response), and RAN AIoT device NGAP ID. The successful reception of this response confirms that the extended transmission occasion was sufficient for the AIoT device 902 to process the command.

At 938, the AIOTF 908 sends a command notify message to the NEF/AF 910. The AIOTF 908 reports the result of the AIoT service operation to the NEF/AF 910 by sending the Naiotf_AIoT_Command notify message. The command notify message includes response information from the AIoT device 902, including AIoT device ID, AIoT data, and AF ID.

At 940, the AIOTF 908 sends an update message to the ADM function 912 to update the AIoT device profile with information that the time for processing of an AIoT command (e.g., including a command type) is increased and optionally the expected time value (e.g., the expected transmission time to perform a command transmission operation that may have been calculated at 926). The update ensures that future command operations for the AIoT device 902 can benefit from the learned timing parameters, reducing or preventing further retransmission and improving overall efficiency. At 942, the ADM function 912 stores the updated processing time information in AIoT device context data, which can be retrieved in future operations, as described with reference to FIG. 8.

The AIOTF 908 may determine that the AIoT device 902 utilizes extended time for AIoT service operation processing based on the response message from the reader device 904. By determining that the AIoT device 902 utilizes longer processing time, the AIOTF 908 provides assistance information including expected service processing time indication to the reader device 904 to assist the calculation of the D2R occasion or the Toffset time period. The indication provides for the reader device 904 to assign longer time period for the D2R occasion, such that the AIoT device 902 may successfully process the AIoT request.

The reader device 904 can obtain an indication that an expected service processing time for an AIoT device 902 satisfies a threshold value through failure detection at 930. To satisfy the threshold value, the expected service processing time may exceed or be greater than the threshold value. The reader device 904 can determine a duration of an extended transmission occasion according to the expected service processing time and can transmit signaling to the AIoT device 902, such as the R2D message at 932. The AIoT device 902 can receive signaling from the AIoT device 902 during the extended transmission occasion at 934. The processes described in the signaling diagram 900 can be applied for public networks and/or for private networks. The features and processes described in the signaling diagram 900 can accommodate various network architectures and deployment scenarios, providing a flexible framework for managing AIoT device communications with varying processing time requirements.

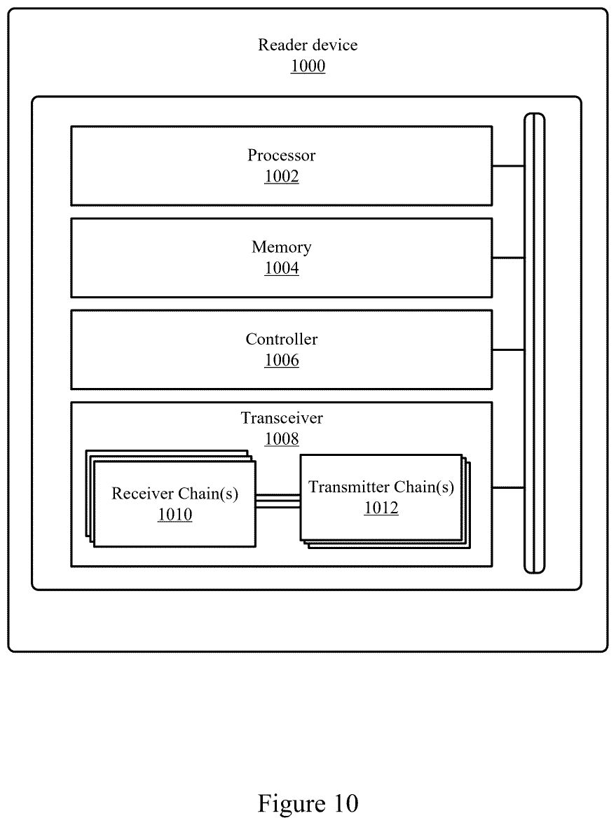

FIG. 10 illustrates an example of a reader device 1000 in accordance with aspects of the present disclosure. The reader device 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces. The reader device 1000 may be an example of a UE, an NE, or any other device that communicates with an AIoT device or other IoT device.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field-programmable gate-array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the reader device 1000 to perform various functions of the present disclosure.

The memory 1004 may include volatile or non-volatile memory. The memory 1004 may store computer-readable, computer-executable code including instructions when executed by the processor 1002 cause the reader device 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the reader device 1000 to perform one or more of the functions described herein (e.g., executing, by the processor 1002, instructions stored in the memory 1004). For example, the processor 1002 may support wireless communication at the reader device 1000 in accordance with examples as disclosed herein. The reader device 1000 may be configured to or operable to support a means for obtaining an indication that an expected service processing time associated with an AIoT device satisfies a threshold value, determining, based on the expected service processing time associated with the AIoT device, a duration of an occasion associated with transmission of a second signaling from the AIoT device to the reader device, transmitting a first signaling to the AIoT device, and receiving, during the occasion and responsive to the first signaling, the second signaling from the AIoT device.

Additionally, the reader device 1000 may be configured to support any one or combination of the indication is obtained from an AIOTF based on a command request message, where the command request message includes one or more of a value of the expected service processing time, a battery storage capability of the AIoT device associated with the expected service processing time, an energy harvesting capability of the AIoT device associated with the expected service processing time, or a signal quality between the AIoT device and the device, an ID associated with a network function associated with the command request message, location information that indicates a location of the AIoT device, or identification information associated with the AIoT device. Additionally, or alternatively, the reader device 1000 may be configured to support transmitting, prior to the first signaling, third signaling to the AIoT device, determining a failure to receive fourth signaling responsive to the third signaling during an additional transmission occasion between reception of the third signaling at the AIoT device and transmission of the fourth signaling at the AIoT device, and outputting, to an AIOTF, a notification indicating one or more of a failure to receive the fourth signaling from the AIoT device during the additional transmission occasion or a duration of the additional transmission occasion, where the second signaling includes a retransmission of the fourth signaling, and where the indication is obtained from the AIOTF responsive to the notification. Additionally, or alternatively, the reader device 1000 may be configured to support a threshold response time associated with the fourth signaling is extended based on the occasion being greater than or equal to the threshold response time. Additionally, or alternatively, the reader device 1000 may be configured to support the expected service processing time associated with the AIoT device is based on one or more of a size of a command request message from the reader device, a size of a command response message from the AIoT device, or the duration of the additional transmission occasion, where the first signaling includes the command request message, and where the second signaling includes the command response message.

Additionally, or alternatively, the reader device 1000 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. Additionally, or alternatively, the reader device 1000 may be configured to support the indication indicates a failure corresponding to transmission or reception of a first command message, and where the first signaling includes a second command message that is a retransmission of the first command message based on the failure. Additionally, or alternatively, the reader device 1000 may be configured to support stored AIoT context data associated with the AIoT device is updated based on one or more of a value of the expected service processing time, a battery storage capability of the AIoT device associated with the expected service processing time, an energy harvesting capability of the AIoT device associated with the expected service processing time, or a signal quality between the AIoT device and the reader device.

Additionally, or alternatively, the reader device 1000 may support at least one memory (e.g., the memory 1004) and at least one processor (e.g., the processor 1002) coupled with the at least one memory and configured to cause the UE to obtain an indication that an expected service processing time associated with an AIoT device satisfies a threshold value, determine, based on the expected service processing time associated with the AIoT device, a duration of an occasion associated with transmission of a second signaling from the AIoT device to the reader device, transmit a first signaling to the AIoT device, and receive, during the occasion and responsive to the first signaling, the second signaling from the AIoT device.

Additionally, the reader device 1000 may be configured to support any one or combination of the indication is obtained from an AIOTF based on a command request message, where the command request message includes one or more of a value of the expected service processing time, a battery storage capability of the AIoT device associated with the expected service processing time, an energy harvesting capability of the AIoT device associated with the expected service processing time, or a signal quality between the AIoT device and the device, an ID associated with a network function associated with the command request message, location information that indicates a location of the AIoT device, or identification information associated with the AIoT device. Additionally, or alternatively, the reader device 1000 may be configured to support to transmit, prior to the first signaling, third signaling to the AIoT device, determine a failure to receive fourth signaling responsive to the third signaling during an additional occasion between reception of the third signaling at the AIoT device and transmission of the fourth signaling at the AIoT device, and output, to an AIOTF, a notification indicating one or more of a failure to receive the fourth signaling from the AIoT device during the additional occasion or a duration of the additional occasion, where the second signaling includes a retransmission of the fourth signaling, and where the indication is obtained from the AIOTF responsive to the notification. Additionally, or alternatively, the reader device 1000 may be configured to support a threshold response time associated with the fourth signaling is extended based on the occasion being greater than or equal to the threshold response time. Additionally, or alternatively, the reader device 1000 may be configured to support the expected service processing time associated with the AIoT device is based on one or more of a size of a command request message from the reader device, a size of a command response message from the AIoT device, or the duration of the additional occasion, where the first signaling includes the command request message, where the second signaling includes the command response message.

Additionally, or alternatively, the reader device 1000 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. Additionally, or alternatively, the reader device 1000 may be configured to support the indication indicates a failure corresponding to transmission or reception of a first command message, where the first signaling includes a second command message that is a retransmission of the first command message based on the failure. Additionally, or alternatively, the reader device 1000 may be configured to support stored AIoT context data associated with the AIoT device is updated based on one or more of a value of the expected service processing time, a battery storage capability of the AIoT device associated with the expected service processing time, an energy harvesting capability of the AIoT device associated with the expected service processing time, or a signal quality between the AIoT device and the reader device.

The controller 1006 may manage input and output signals for the reader device 1000. The controller 1006 may also manage peripherals not integrated into the reader device 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the reader device 1000 may include at least one transceiver 1008. In some other implementations, the reader device 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

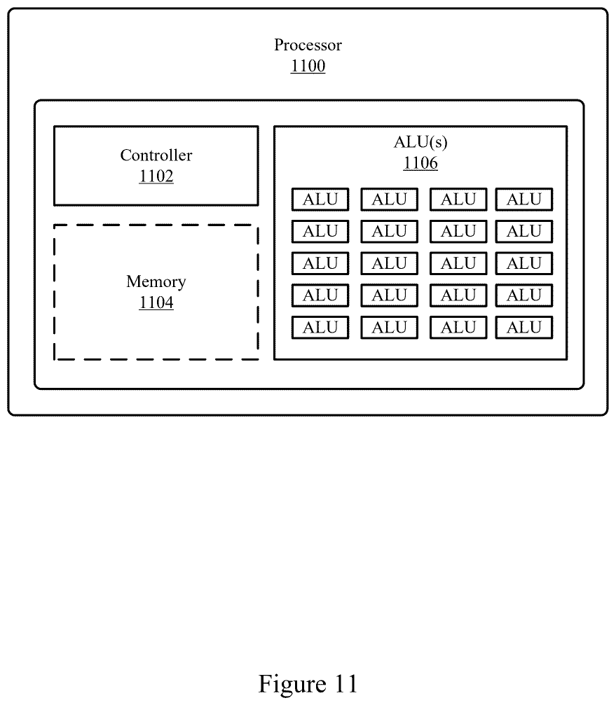

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may be configured to or operable to support at least one controller (e.g., the controller 1102) coupled with at least one memory (e.g., the memory 1104) and configured to cause the processor to obtain an indication that an expected service processing time associated with an AIoT device satisfies a threshold value, determine, based on the expected service processing time associated with the AIoT device, a duration of an occasion associated with transmission of a second signaling from the AIoT device to the processor 1100, transmit a first signaling to the AIoT device, and receive, during the occasion and responsive to the first signaling, the second signaling from the AIoT device.

Additionally, the processor 1100 may be configured to or operable to support any one or combination of the indication is obtained from an AIOTF based on a command request message, where the command request message includes one or more of a value of the expected service processing time, a battery storage capability of the AIoT device associated with the expected service processing time, an energy harvesting capability of the AIoT device associated with the expected service processing time, or a signal quality between the AIoT device and the device, an ID associated with a network function associated with the command request message, location information that indicates a location of the AIoT device, or identification information associated with the AIoT device. Additionally, or alternatively, the processor 1100 may be configured to support to transmit, prior to the first signaling, third signaling to the AIoT device, determine a failure to receive fourth signaling responsive to the third signaling during an additional occasion between reception of the third signaling at the AIoT device and transmission of the fourth signaling at the AIoT device, and output, to an AIOTF, a notification indicating one or more of a failure to receive the fourth signaling from the AIoT device during the additional occasion or a duration of the additional occasion, where the second signaling includes a retransmission of the fourth signaling, and where the indication is obtained from the AIOTF responsive to the notification. Additionally, or alternatively, the processor 1100 may be configured to support a threshold response time associated with the fourth signaling is extended based on the occasion being greater than or equal to the threshold response time. Additionally, or alternatively, the processor 1100 may be configured to support the expected service processing time associated with the AIoT device is based on one or more of a size of a command request message from the processor 1100, a size of a command response message from the AIoT device, or the duration of the additional occasion, where the first signaling includes the command request message, and where the second signaling includes the command response message.

Additionally, or alternatively, the processor 1100 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the processor 1100, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the processor 1100. Additionally, or alternatively, the processor 1100 may be configured to support the indication indicates a failure corresponding to transmission or reception of a first command message, where the first signaling includes a second command message that is a retransmission of the first command message based on the failure. Additionally, or alternatively, the processor 1100 may be configured to support stored AIoT context data associated with the AIoT device is updated based on one or more of a value of the expected service processing time, a battery storage capability of the AIoT device associated with the expected service processing time, an energy harvesting capability of the AIoT device associated with the expected service processing time, or a signal quality between the AIoT device and the processor 1100.

The processor 1100 may be configured to or operable to support at least one controller (e.g., the controller 1102) coupled with at least one memory (e.g., the memory 1104) and configured to cause the processor to output, to a reader device, an indication that an expected service processing time associated with an AIoT device satisfies a threshold value, where a duration of an occasion associated with transmission of signaling from the AIoT device to the reader device is based on the expected service processing time associated with the AIoT device.

Additionally, to output the indication, the processor 1100 may be configured to or operable to support any one or combination of to obtain, from a network function, a command request message including one or more of a value of the expected service processing time, a battery storage capability of the AIoT device associated with the expected service processing time, an energy harvesting capability of the AIoT device associated with the expected service processing time, or a signal quality between the AIoT device and the reader device, an ID associated with the network function, location information that indicates a location of the AIoT device, or identification information associated with the AIoT device. Additionally, or alternatively, to output the indication the processor 1100 may be configured to support to obtain, from the reader device, a notification indicating one or more of a failure to receive the signaling from the AIoT device during an additional occasion prior to the occasion or a duration of the additional occasion. Additionally, or alternatively, the processor 1100 may be configured to support a threshold response time associated with the additional signaling is extended based on the occasion being greater than or equal to the threshold response time. Additionally, or alternatively, the processor 1100 may be configured to support the expected service processing time associated with the AIoT device is based on one or more of a size of a command request message from the reader device, a size of a command response message from the AIoT device, or the duration of the additional occasion, where the signaling includes the command response message.

Additionally, or alternatively, the processor 1100 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. Additionally, or alternatively, the processor 1100 may be configured to support the indication indicates a failure corresponding to transmission or reception of a first command message, where a second command message that is a retransmission of the first command message is transmitted based on the indication. Additionally, or alternatively, the processor 1100 may be configured to support to output, to an ADM function, a request to update AIoT data associated with the AIoT device based on one or more of a value of the expected service processing time, a battery storage capability of the AIoT device associated with the expected service processing time, an energy harvesting capability of the AIoT device associated with the expected service processing time, or a signal quality between the AIoT device and the reader device. Additionally, or alternatively, the processor 1100 may be configured to support the indication is output in a command request message, and to obtain, in response to the command request message, a command response message associated with the signaling. Additionally, or alternatively, the processor 1100 may be configured to support the processor 1100 implements an AIOTF.

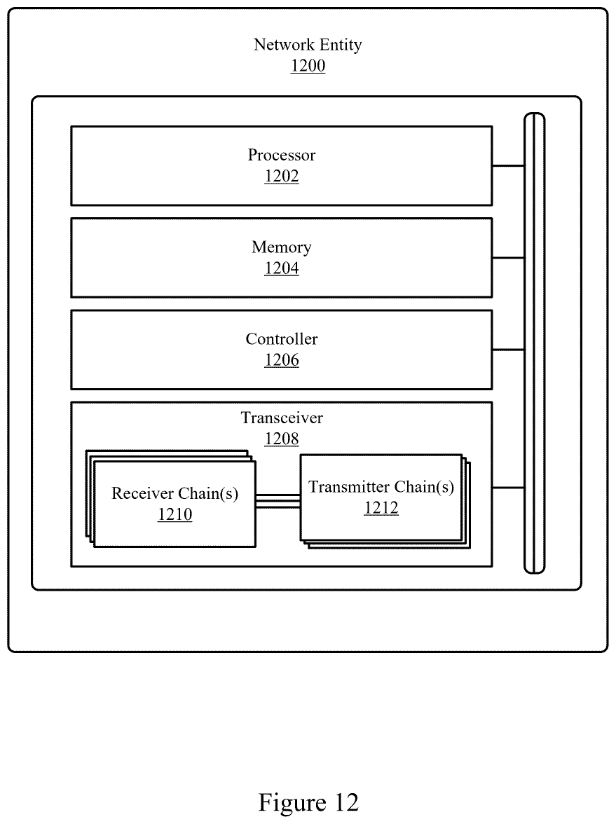

FIG. 12 illustrates an example of an network entity 1200 in accordance with aspects of the present disclosure. The network entity 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces. The network entity 1200 may be an example of an NE, a CN, or any other network device that implements or includes network functions, such as an AIOTF.

The processor 1202, the memory 1204, the controller 1206, or the transceiver 1208, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the network entity 1200 to perform various functions of the present disclosure.

The memory 1204 may include volatile or non-volatile memory. The memory 1204 may store computer-readable, computer-executable code including instructions when executed by the processor 1202 cause the network entity 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the network entity 1200 to perform one or more of the functions described herein (e.g., executing, by the processor 1202, instructions stored in the memory 1204). For example, the processor 1202 may support wireless communication at the network entity 1200 in accordance with examples as disclosed herein. The network entity 1200 may be configured to or operable to support a means for outputting, to a reader device, an indication that an expected service processing time associated with an AIoT device satisfies a threshold value, where a duration of an occasion associated with transmission of signaling from the AIoT device to the reader device is based on the expected service processing time associated with the AIoT device.

Additionally, to output the indication, the network entity 1200 may be configured to or operable to support any one or combination of obtaining, from a network function, a command request message including one or more of a value of the expected service processing time, a battery storage capability of the AIoT device associated with the expected service processing time, an energy harvesting capability of the AIoT device associated with the expected service processing time, or a signal quality between the AIoT device and the reader device, an ID associated with the network function, location information that indicates a location of the AIoT device, or identification information associated with the AIoT device. Additionally, or alternatively, to output the indication, the network entity 1200 may be configured to support obtaining, from the reader device, a notification indicating one or more of a failure to receive the signaling from the AIoT device during an additional occasion prior to the occasion or a duration of the additional occasion. Additionally, or alternatively, the network entity 1200 may be configured to support a threshold response time associated with the additional signaling is extended based on the occasion being greater than or equal to the threshold response time. Additionally, or alternatively, the network entity 1200 may be configured to support the expected service processing time associated with the AIoT device is based on one or more of a size of a command request message from the reader device, a size of a command response message from the AIoT device, or the duration of the additional occasion, where the signaling includes the command response message.

Additionally, or alternatively, the network entity 1200 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. Additionally, or alternatively, the network entity 1200 may be configured to support the indication indicates a failure corresponding to transmission or reception of a first command message, where a second command message that is a retransmission of the first command message is transmitted based on the indication. Additionally, or alternatively, the network entity 1200 may be configured to support output, to an ADM function, a request to update AIoT data associated with the AIoT device based on one or more of a value of the expected service processing time, a battery storage capability of the AIoT device associated with the expected service processing time, an energy harvesting capability of the AIoT device associated with the expected service processing time, or a signal quality between the AIoT device and the reader device. Additionally, or alternatively, the network entity 1200 may be configured to support the indication is output in a command request message, and obtaining, in response to the command request message, a command response message associated with the signaling. Additionally, or alternatively, the network entity 1200 may be configured to support the network entity implements an AIOTF.

Additionally, or alternatively, the network entity 1200 may support at least one memory (e.g., the memory 1204) and at least one processor (e.g., the processor 1202) coupled with the at least one memory and configured to cause the network entity to output, to a reader device, an indication that an expected service processing time associated with an AIoT device satisfies a threshold value, where a duration of an occasion associated with transmission of signaling from the AIoT device to the reader device is based on the expected service processing time associated with the AIoT device.

Additionally, to output the indication, the network entity 1200 may be configured to support any one or combination of to obtain, from a network function, a command request message including one or more of a value of the expected service processing time, a battery storage capability of the AIoT device associated with the expected service processing time, an energy harvesting capability of the AIoT device associated with the expected service processing time, or a signal quality between the AIoT device and the reader device, an ID associated with the network function, location information that indicates a location of the AIoT device, or identification information associated with the AIoT device. Additionally, or alternatively, to output the indication, the network entity 1200 may be configured to support to obtain, from the reader device, a notification indicating one or more of a failure to receive the signaling from the AIoT device during an additional occasion prior to the occasion or a duration of the additional occasion. Additionally, or alternatively, the network entity 1200 may be configured to support a threshold response time associated with the additional signaling is extended based on the occasion being greater than or equal to the threshold response time. Additionally, or alternatively, the network entity 1200 may be configured to support the expected service processing time associated with the AIoT device is based on one or more of a size of a command request message from the reader device, a size of a command response message from the AIoT device, or the duration of the additional transmission occasion, where the signaling includes the command response message.

Additionally, or alternatively, the network entity 1200 may be configured to support the indication includes one or more of a value of the expected service processing time, a battery storage capability of the AIoT device associated with the expected service processing time, an energy harvesting capability of the AIoT device associated with the expected service processing time, or a signal quality between the AIoT device and the reader device, and the duration of the occasion is based on one or more of the value of the expected service processing time, the battery storage capability of the AIoT device associated with the expected service processing time, the energy harvesting capability of the AIoT device associated with the expected service processing time, or the signal quality between the AIoT device and the reader device. Additionally, or alternatively, the network entity 1200 may be configured to support the indication indicates a failure corresponding to transmission or reception of a first command message, where a second command message that is a retransmission of the first command message is transmitted based on the indication. Additionally, or alternatively, the network entity 1200 may be configured to support output, to an ADM function, a request to update AIoT data associated with the AIoT device based on one or more of a value of the expected service processing time, a battery storage capability of the AIoT device associated with the expected service processing time, an energy harvesting capability of the AIoT device associated with the expected service processing time, or a signal quality between the AIoT device and the reader device. Additionally, or alternatively, the network entity 1200 may be configured to support the indication is output in a command request message, and to obtain, in response to the command request message, a command response message associated with the signaling. Additionally, or alternatively, the network entity 1200 may be configured to support the network entity implements an AIOTF.

The controller 1206 may manage input and output signals for the network entity 1200. The controller 1206 may also manage peripherals not integrated into the network entity 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the network entity 1200 may include at least one transceiver 1208. In some other implementations, the network entity 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., an LNA) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

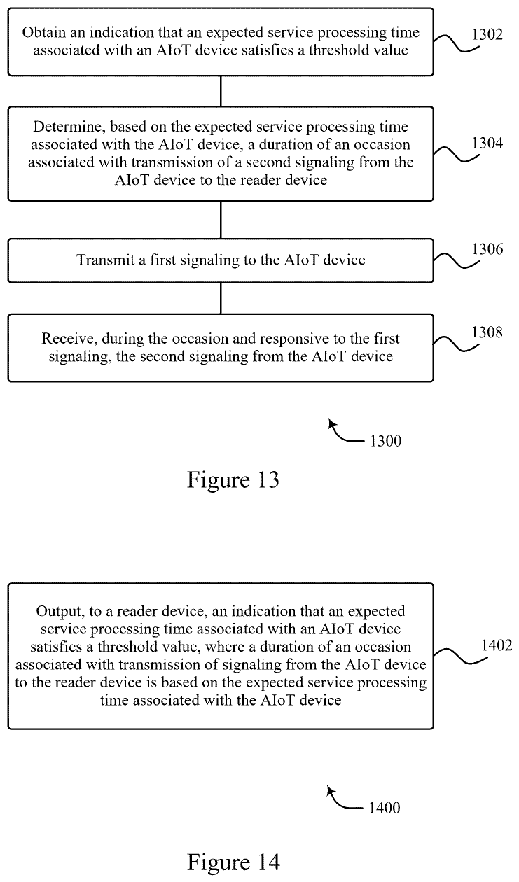

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include obtaining an indication that an expected service processing time associated with an AIoT device satisfies a threshold value. The operations of 1302 may be performed in accordance with examples as described herein. In some implementations, aspects of the operations of 1302 may be performed by a reader device as described with reference to FIG. 10.

At 1304, the method may include determining, based on the expected service processing time associated with the AIoT device, a duration of an occasion associated with transmission of a second signaling from the AIoT device to the reader device. The operations of 1304 may be performed in accordance with examples as described herein. In some implementations, aspects of the operations of 1304 may be performed by a reader device as described with reference to FIG. 10.

At 1306, the method may include transmitting a first signaling to the AIoT device. The operations of 1306 may be performed in accordance with examples as described herein. In some implementations, aspects of the operations of 1306 may be performed a reader device as described with reference to FIG. 10.

At 1308, the method may include receiving, during the occasion and responsive to the first signaling, the second signaling from the AIoT device. The operations of 1308 may be performed in accordance with examples as described herein. In some implementations, aspects of the operations of 1308 may be performed a reader device as described with reference to FIG. 10.

FIG. 14 illustrates a flowchart of a method 1400 in accordance with aspects of the present disclosure. The operations of the method may be implemented by an network entity (e.g., implementing or including a network function) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 1402, the method may include outputting, to a reader device, an indication that an expected service processing time associated with an AIoT device satisfies a threshold value, where a duration of an occasion associated with transmission of signaling from the AIoT device to the reader device is based on the expected service processing time associated with the AIoT device. The operations of 1402 may be performed in accordance with examples as described herein. In some implementations, aspects of the operations of 1402 may be performed by an network entity as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A reader device for wireless communication, comprising:
at least one memory; and
at least one processor coupled with the at least one memory and operable to cause the reader device to:
obtain an indication that an expected service processing time associated with an ambient internet of things (AIoT) device satisfies a threshold value;
determine, based at least in part on the expected service processing time associated with the AIoT device, a duration of an occasion associated with transmission of a second signaling from the AIoT device to the reader device;
transmit a first signaling to the AIoT device; and
receive, during the occasion and responsive to the first signaling, the second signaling from the AIoT device.

2. The reader device of claim 1, wherein the indication is obtained from an AIoT function (AIOTF) based at least in part on a command request message, and wherein the command request message comprises one or more of a value of the expected service processing time, a battery storage capability of the AIoT device associated with the expected service processing time, an energy harvesting capability of the AIoT device associated with the expected service processing time, or a signal quality between the AIoT device and the reader device, an identifier (ID) associated with a network function associated with the command request message, location information that indicates a location of the AIoT device, or identification information associated with the AIoT device.

3. The reader device of claim 1, wherein the at least one processor is further operable to cause the reader device to:
transmit, prior to the first signaling, third signaling to the AIoT device;
determine a failure to receive fourth signaling responsive to the third signaling during an additional occasion between reception of the third signaling at the AIoT device and transmission of the fourth signaling at the AIoT device; and
output, to an AIoT function (AIOTF), a notification indicating one or more of the failure to receive the fourth signaling from the AIoT device during the additional occasion or a duration of the additional occasion, wherein the second signaling comprises a retransmission of the fourth signaling, and wherein the indication is obtained from the AIOTF responsive to the notification.

4. The reader device of claim 3, wherein a threshold response time associated with the fourth signaling is extended based at least in part on the occasion being greater than or equal to the threshold response time.

5. The reader device of claim 3, wherein the expected service processing time associated with the AIoT device is based at least in part on one or more of a size of a command request message from the reader device, a size of a command response message from the AIoT device, or the duration of the additional occasion, wherein the first signaling comprises the command request message, and wherein the second signaling comprises the command response message.

6. The reader device of claim 1, wherein:
the indication comprises one or more of a value of the expected service processing time, a battery storage capability of the AIoT device associated with the expected service processing time, an energy harvesting capability of the AIoT device associated with the expected service processing time, or a signal quality between the AIoT device and the reader device; and
the duration of the occasion is based at least in part on one or more of the value of the expected service processing time, the battery storage capability of the AIoT device associated with the expected service processing time, the energy harvesting capability of the AIoT device associated with the expected service processing time, or the signal quality between the AIoT device and the reader device.

7. The reader device of claim 1, wherein the indication indicates a failure corresponding to transmission or reception of a first command message, and wherein the first signaling comprises a second command message that is a retransmission of the first command message based at least in part on the failure.

8. The reader device of claim 1, wherein stored AIoT context data associated with the AIoT device is updated based at least in part on one or more of a value of the expected service processing time, a battery storage capability of the AIoT device associated with the expected service processing time, an energy harvesting capability of the AIoT device associated with the expected service processing time, or a signal quality between the AIoT device and the reader device.

9. A method performed by a reader device, the method comprising:
obtaining an indication that an expected service processing time associated with an ambient internet of things (AIoT) device satisfies a threshold value;
determining, based at least in part on the expected service processing time associated with the AIoT device, a duration of an occasion associated with transmission of a second signaling from the AIoT device to the reader device;
transmitting a first signaling to the AIoT device; and
receiving, during the occasion and responsive to the first signaling, the second signaling from the AIoT device.

10. A network entity for wireless communication, comprising:
at least one memory; and
at least one processor coupled with the at least one memory and operable to cause the network entity to output, to a reader device, an indication that an expected service processing time associated with an ambient internet of things (AIoT) device satisfies a threshold value, wherein a duration of an occasion associated with transmission of signaling from the AIoT device to the reader device is based at least in part on the expected service processing time associated with the AIoT device.

11. The network entity of claim 10, wherein to output the indication, the at least one processor is further operable to cause the network entity to obtain, from a network function, a command request message comprising one or more of a value of the expected service processing time, a battery storage capability of the AIoT device associated with the expected service processing time, an energy harvesting capability of the AIoT device associated with the expected service processing time, or a signal quality between the AIoT device and the reader device, an identifier (ID) associated with the network function, location information that indicates a location of the AIoT device, or identification information associated with the AIoT device.

12. The network entity of claim 10, wherein to output the indication, the at least one processor is further operable to cause the network entity to obtain, from the reader device, a notification indicating one or more of a failure to receive the signaling from the AIoT device during an additional occasion prior to the occasion or a duration of the additional occasion.

13. The network entity of claim 12, wherein a threshold response time associated with the signaling is extended based at least in part on the occasion being greater than or equal to the threshold response time.

14. The network entity of claim 12, wherein the expected service processing time associated with the AIoT device is based at least in part on one or more of a size of a command request message from the reader device, a size of a command response message from the AIoT device, or the duration of the additional occasion, wherein the signaling comprises the command response message.

15. The network entity of claim 10, wherein:
the indication comprises one or more of a value of the expected service processing time, a battery storage capability of the AIoT device associated with the expected service processing time, an energy harvesting capability of the AIoT device associated with the expected service processing time, or a signal quality between the AIoT device and the reader device; and
the duration of the occasion is based at least in part on one or more of the value of the expected service processing time, the battery storage capability of the AIoT device associated with the expected service processing time, the energy harvesting capability of the AIoT device associated with the expected service processing time, or the signal quality between the AIoT device and the reader device.

16. The network entity of claim 10, wherein the indication indicates a failure corresponding to transmission or reception of a first command message, and wherein a second command message that is a retransmission of the first command message is transmitted based at least in part on the indication.

17. The network entity of claim 10, wherein the at least one processor is further operable to cause the network entity to output, to an AIoT data management (ADM) function, a request to update AIoT data associated with the AIoT device based at least in part on one or more of a value of the expected service processing time, a battery storage capability of the AIoT device associated with the expected service processing time, an energy harvesting capability of the AIoT device associated with the expected service processing time, or a signal quality between the AIoT device and the reader device.

18. The network entity of claim 10, wherein the indication is output in a command request message, and wherein the at least one processor is further operable to cause the network entity to obtain, in response to the command request message, a command response message associated with the signaling.

19. The network entity of claim 10, wherein the network entity implements an AIoT function (AIOTF).

20. A method performed by a network entity, the method comprising outputting, to a reader device, an indication that an expected service processing time associated with an ambient internet of things (AIoT) device satisfies a threshold value, wherein a duration of a transmission occasion associated with transmission of signaling from the AIoT device to the reader device is based at least in part on the expected service processing time associated with the AIoT device.
